(19) United States
(12) Patent Application Publication
(10) Pub. No.: US 2021/0331122 A1
(43) Pub. Date: Oct. 28, 2021

(54) TWO-DIMENSIONAL NANOPOROUS COVALENT ORGANIC FRAMEWORK FOR SELECTIVE SEPARATION AND FILTRATION MEMBRANE FORMED THEREFROM

(71) Applicant: University of Wyoming, Laramie, WY (US)

(72) Inventors: Katie Dongmei Li-Oakey, Laramie, WY (US); Jiashi Yin, Laramie, WY (US); Phuoc Hoang-Hanh Duong, Laramie, WY (US)

(73) Assignee: University of Wyoming, Laramie, WY (US)

(21) Appl. No.: 17/268,138

(22) PCT Filed: Aug. 14, 2019
(86) PCT No.: PCT/US2019/046528

§ 371 Date: Feb. 12, 2021

Related U.S. Application Data
(60) Provisional application No. 62/718,548, filed on Aug. 14, 2018.
(60) Provisional application No. 62/845,723, filed on May 9, 2019.

(51) Int. Cl. B01D 69/14; C08L 33/20; C08J 9/00; C08J 9/28; B01D 69/02; B01D 61/02; B01D 69/10; B01D 71/42; B01D 71/82; C02F 1/44; B01D 53/22

(52) U.S. Cl. CPC B01D 69/141; C02F 2103/10; C08J 9/0061; C08J 9/286; B01D 69/02; B01D 61/027; B01D 69/10; B01D 71/42; B01D 71/82; C02F 1/442; B01D 53/228; C08J 2201/0544; C08J 2333/20; C08J 2471/02; B01D 2325/20; B01D 2325/30; C08L 33/20

(57) ABSTRACT

A membrane filter is provided. The membrane filter including an ordered functional nanoporous material (OFNM) defining a layer and a membrane support. The layer having a two-dimensional structure and defining a plurality of pores and imparting to the membrane filter a permeance of at least 900 Lm⁻²h⁻¹bar⁻¹ and a rejection of at least 60% as to a solvent containing a filterable species.

### FIELD OF THE INVENTION

The present invention in general relates to filtration membranes and in particular to nanoporous polymeric material membranes with high filtration selectivity and paradoxically high permeance.

### BACKGROUND OF THE INVENTION

The past decade has seen an explosion of interest in two-dimensional (2D) materials that started with the demonstration of the extraordinary properties of graphene, and has been extended to other 2D materials, such as transition metal dichalcogenides, nanoplatelets and other elemental 2D phases (germanene, silicene, etc.). (1) The promise of 2D materials is largely based on their unique single-layer electrical, optical, and magnetic properties. However, current 2D materials are not easily modified to suit a given application: that is, there is very little flexibility in adjusting the materials performance beyond their intrinsic properties. This rigidity and lack of adaptability presents significant barriers to technological implementation and broad use. Attempts have been made to achieve this goal by modifying graphene. For example, a top down approach using ion bombardment, (2) etching (3) or oxidations, (4) produces graphene oxide (GO) with pores containing a high degree of polydispersity in both size and density. These randomly produced pores start to overlap when produced at high density producing both larger openings and weakening the material. In fact, variations in the degree of oxidation caused by differences in starting materials (principally the graphite source) or oxidation protocol can cause substantial variation in the structure and properties of the material. (5) As a result, permeation (flux) through GO membranes remains insufficient to technically compete with current commercial pressure-driven membranes. (6) This challenging task of creating atomically precise nanopores, without destroying the material itself, has thus remained elusive. However, just recently a bottom-up synthesis of a nanoporous “graphene” was reported, (7) providing a material with ordered nanopores while maintaining the integrity of the graphene. Although this bottom-up strategy proved to be successful in the monolayer regime, the nine-step synthesis provides only nanogram quantities and did not produce a material capable of pore functionalization. Metal organic framework materials have also been investigated for membrane production however they suffer from their 3D structures where membranes have to be fabricated with grains of these materials where species can diffuse in the spaces between grains rather than through the porous structure. A 2D material can naturally produce a membrane without this possibility via the natural stacking of the 2D grains as in graphene oxide where the size selection has actually been attributed to the tortuous diffusion path between the layers. These ordered and completely engineered pores might have great efficacy across multiple applications, including high performance separations.

Separations are fundamental to life processes, analytical protocols, industrial processes and consumes greater than 10% of world energy use. (10) Many of the conventional separation techniques, such as distillation, extraction and chromatographies, are both time and energy intensive. In addition, ion or gas permeable membranes are vital to the operation of virtually all electrochemical devices including batteries, fuel cells, electrolyzers and desalinization systems. Additionally, it is well known in the art that the relationship of throughput and selectivity of a filter is generally inversely proportional.

Accordingly, there exists a need for a membrane for separations that has both high throughput and highly selective transport or rejection of the species of interest based on size, charge or other molecular properties.

### SUMMARY OF THE INVENTION

The present invention provides a membrane filter including an ordered functional nanoporous material (OFNM) defining a layer and a membrane support. The layer having a two-dimensional structure and defining a plurality of pores and imparting to the membrane filter a permeance of at least 900 Lm⁻²h⁻¹bar⁻¹ and a rejection of at least 60% as to a solvent containing a filterable species.

The present disclosure provides highly ordered 2D COF materials with tunable pores and demonstrated the synthesis of multiple pore functionalities. According to embodiments, a cation selective membrane with precise size-selectivity is provided. The synthetic flexibility of this system allows for rational design and synthesis of membrane materials for many different types of separations based on size, charge, hydrophobicity and hydrophilicity among others with potential applications in desalinization, non-protein fouling membranes, fuel cell membranes, redox flow battery membranes, dialysis membranes, gas separation membranes and other technologies requiring membrane separations, with some of them already being pursued in our laboratories.

### BRIEF DESCRIPTION OF THE DRAWINGS

The present invention is further detailed with respect to the following drawings. These figures are not intended to limit the scope of the present invention but rather illustrate certain attributes thereof.

FIG. 1 shows a schematic representation of the synthesis of COFs 6-10 with space-filling model, black=carbon, red=oxygen (pores 8 and 9), dark red=bromine (pore 7), purple=nitrogen, yellow=hydrogen;

FIG. 2A-2C show a series of TEM images showing well-ordered, 2D flakes on the order of 500 nm of 9;

FIG. 2D shows real to reciprocal space image corresponding exactly to the electron diffraction pattern seen in FIG. 2F, the bright spots in the image describe the reciprocal lattice of the synthesized flakes;

FIG. 2E shows a two-dimensional Fourier transform of simulated COF;

FIG. 2F shows an electron diffraction pattern seen corresponding to FIG. 2D;

FIG. 3 is a graph showing powder x-ray diffraction of COF 9 from FIGS. 2A-2F, with X-ray line widths of xx° being consistent with the grain size of the crystallite structures in the TEM images;

FIG. 4 is a graph showing a titration curve of COF material dispersed in NaOH solution;

FIG. 5 is a graph showing cation selectivity of neat track-etched polycarbonate (TEPC) and COF/TEPC supported membrane (ethanol);

FIG. 6 shows Space-filling models of a single pore of COF 9 with Bu₄N⁺ (A), Hex₄N⁺ (B) and Oct₄N⁺ (C) cations inside the pore;

FIG. 7 shows a schematic of an inventive filter membrane selectively filtering particles;

FIG. 8 is a schematic illustration showing the fabrication of a mixed-matrix ultrafiltration membrane and molecular structures of the polymer matrix (polyacrylonitrile) and the 2D nanofiller (COF) according to embodiments of the present invention;

FIGS. 9A-9E are AFM 3D topographical images of membrane surfaces;

FIG. 9F is a table showing the surface roughness parameters of the AFM 3D topographical images of FIGS. 9A-9E;

FIG. 10 is a graph showing pore size distribution of membranes having 0-0.8 wt % COF;

FIG. 11 is a table of pure water permeance, protein separation, porosity, and water contact angle of membranes with photographs of the various membranes;

FIGS. 12A-12E are fluorescence microscopy images of membrane surfaces;

FIG. 12F is a graph showing relative protein adsorption on membrane surfaces of FIGS. 12A-12E after 1 h exposure to 1000 ppm BSA-FITC in PBS;

FIG. 13 is a graph showing flux decline curves using 1000 ppm BSA in PBS solution as the feed;

FIG. 14 A shows the molecular structure of tertiary amine functionalized COF (N-COF);

FIG. 14B shows the molecular structure of carboxyl functionalized COF (C-COF);

FIGS. 15A-15E show the molecular structures of organic dyes;

FIG. 16 is a schematic illustration for TFN nanofiltration membrane preparation according to embodiments of the present invention;

FIGS. 17A and 17B are graphs showing permeance and rejection, respectively;

FIG. 18 is a table showing a comparison of separation performance of membranes using two solutes having similar molecular weight, Indigo Carmine (negative charge) and Rhodamine B (positive charge);

FIGS. 19A-19D are graphs showing the effect of COF concentration on membrane performance;

FIGS. 20A and 20B show water permeance and Orange II (Mw: 350 g mol-1) rejection, respectively, of nanofiltration membranes having 0-20 wt % N-COF;

FIGS. 21A and 21B show water permeance and Orange II (Mw: 350 g mol-1) rejection, respectively, of nanofiltration membranes having 0-20 wt % C-COF;

FIG. 22 is a graph showing the ATR-FTIR spectra of polyamide membranes having 0-20 wt % C-COF and FTIR spectrum of C-COF powder;

FIG. 23 is a graph showing the ATR-FTIR spectra of polyamide membranes having 0-20 wt % N-COF and FTIR spectrum of N-COF powder;

FIGS. 24A-24C show SEM morphology of membrane surfaces of pristine polyamide, 5% C-COF, and 20% C-COF, respectively;

FIGS. 24D-24F show AFM topography of membrane surfaces of pristine polyamide, 5% C-COF, and 20% C-COF, respectively;

FIGS. 25A-25C show SEM morphology of membrane surfaces of pristine polyamide, 5% N-COF, and 20% N-COF, respectively;

FIGS. 25D-25F show AFM topography of membrane surfaces of pristine polyamide, 5% N-COF, and 20% N-COF, respectively;

FIG. 26 is a graph showing TGA curves of the pristine (0% COF), 20% C-COF, and 20% N-COF incorporated polyamide films;

FIG. 27A shows the molecular structure of carboxyl-functionalized COF (C-COF);

FIG. 27B is a cross-sectional SEM image of a C-COF/AAO membrane;

FIG. 27C is a surface SEM micrograph of C-COF/AAO membrane;

FIG. 27D is a zoomed in surface SEM image of a smooth region of the C-COF/AAO membrane;

FIG. 28A is a sketch of water transport pathways through layer-stacked C-COF/AAO membranes and the pure water permeance;

FIG. 28B is a graph showing the effect of the transmembrane pressure on water permeance through C-COF/AAO membranes;

FIG. 28C shows the membrane rejection towards different dyes;

FIGS. 29A and 29B show a cross-sectional SEM images of C-COF/AAO membranes before and after 1 h filtration under a transmembrane pressure of 1 bar, respectively, using DI water as a feed;

FIG. 30A is a schematic of the produced water treatment process using C-COF/AAO membranes and photographs of the flowback water before treatment (feed) and the permeate after treatment;

FIG. 30B is a graph showing the UV-vis spectra of the feed and permeate;

FIG. 30C is a table showing the membrane removal rates towards oil and total dissolved solid presented in the flowback water;

FIG. 31A is a table showing weight of permeance during the filtration process using 500 ppm γ-globulin as a feed;

FIG. 31B is a graph showing separation performance of C-COF/AAO and UF-PVDF membranes;

FIG. 32A is a graph showing permeance of pure organic solvents as a function of their inverse viscosity through C-COF/AAO membranes

FIG. 32B is a graph showing permeance of pure organic solvents as a function of their inverse viscosity through (B) previously reported GO/AAO membranes;

FIGS. 33A-33H show UV-vis spectra of solvents used to immerse C-COF/AAO membranes for 1 week and photographs of the membranes after 1 week immersion in solvents;

FIG. 34A shows the molecular structure of Alcian Blue;

FIG. 34B shows the molecular structure of Safranin O;

FIG. 34C is a table showing the rejection of Alcian Blue and Safranin O in basic, neutral, and acidic methanol feed solutions containing single dye;

FIGS. 35A and 35B show rejection of Alcian Blue and Safranin O in basic, neutral, and acidic methanol feed solutions containing both dyes;

FIG. 36 is a graph showing methanol permeance of C-COF/AAO membranes using feeds at different pH;

FIG. 37 is a graph showing rejection of Alcian Blue using basic methanol feeds containing 0-500 ppm NaCl;

FIGS. 38A and 38B show the molecular structures for C-COF and N-COF, respectively;

FIG. 38C shows a schematic representation of the fabrication of LbL-COF/AAO composite membrane;

FIGS. 39A-39D are photographs showing the stability of LbL-COF/AAO composite membrane;

FIG. 40A shows the separation performance of the LbL-COF/AAO composite membrane using a feed solution containing a negatively charged dye (Direct Red 8, Mw: 1373 g/mol);

FIG. 40B shows the separation performance of the LbL-COF/AAO composite membrane using a feed solution containing a positively charged dye (Alcian Blue, Mw: 1299 g/mol) with a similar molecular weight to the dye of FIG. 40A;

FIGS. 41A-41C show the selectivity of LbL-COF/AAO composite membrane towards Alcian Blue in different organic solvents;

FIG. 42 is a table showing the characteristics of various solvents employed;

FIGS. 43A and 43B show the selectivity of LbL-COF/AAO composite membrane towards [Hmim]Cl (Mw: 203 g/mol) and [Bmim]Cl (Mw: 175 g/mol) ionic liquids, respectively;

FIG. 44 shows the molecular structure of a COF used for gas separation membrane fabrication;

FIGS. 45A and 45B are graphs showing COF membrane performance during raw flowback water treatment under a transmembrane pressure of 1 bar;

FIG. 46 is a table showing comparisons of a commercial PVDF UF and C-COF membranes for raw flowback water treatment under a transmembrane pressure of 1 bar;

FIG. 47 is a graph showing flux decline curves of PVDF (Sterlitech, 50 kDa), COF, and PDA-COF membranes operated at the same initial pure water flux of ˜250 Lm⁻²h⁻¹ with a feed solution of pre-treated neat flowback water; and

FIG. 48 is a table showing comparisons of a commercial PVDF, COF, and PDA-treated-COF membranes for neat (pH 6) and acid (pH 1.8) flowback water (FBW) treatment with the flowback water feeds pre-treated using a 0.45 μm PES membrane.

### DESCRIPTION OF THE INVENTION

The present invention provides filtration membranes with high filtration selectivity based on specific chemical properties such as size and charge while also affording high permeance. The membranes of the present disclosure are attractive separators due to their small energy requirements and their potential for both fast and selective separations. Membranes according to embodiments of the present disclosure have atomic scale capillaries that efficiently allow the separation of the species from solutions and suspensions based on properties depending on the molecular and ionic size. (11) According to some inventive embodiments, a membrane is fabricated from a covalent organic framework (COF). As a result, solvent permeance values of more than 900 Lm⁻²h⁻¹bar⁻¹ are achieved and in some inventive embodiments, values of between 900 and 6000 Lm⁻²h⁻¹bar⁻¹ are achieved. In concert with the permanence values obtained through use of an inventive filter, filtered species rejection percentages are achieved that are greater than 60% and in some inventive embodiments between 60 and 95% per single membrane pass.

The present invention provides a novel class of two-dimensional covalent organic framework (COF) polymers that have a highly stable, photoactive, semi-conducting aromatic backbone with intrinsically and exactly ordered nanometer sized pores, and, unlike other COFs, (8, 9), can be functionalized with a variety of functional groups. According to some inventive embodiments, a highly ordered COF is synthesized with ionizable carboxylate groups in 2.8 nm pores and demonstrates high membrane selectivity to only conduct cations smaller than a precise pore size threshold. Additionally, related inventive membranes materials are readily synthesized to either increase or reduce this pore size threshold or make yield anionic selective membranes. These 2D-COF materials achieve the goal of a modifiable, highly ordered material and are synthesized in a bottom up approach, thereby providing both a stable aromatic backbone and producing functionalized pores either in the small precursor molecules or after synthesizing the COF using well known high yield coupling reactions to replace moieties extending into pore areas with substituted moieties so as to modify pore properties. Substituted moieities operative herein illustratively include halogens, amines, hydroxyls, carboxyls, peptides, ammoniums, oniums, alkanes, alkenes, silanes, sulfonyls, and phosphates. It is appreciated that with resort to chiral substituted moieties that chiral selectively is imparted to an inventive membrane.

It is also appreciated the pore moieties are also selective reacted with a cap species, to selectively close a pore. In instances when the cap species is a precious metal or contaminating metal present in low concentrations such as radioactive contaminants, an inventive membrane serves as a cap species accumulator.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

### Synthesis

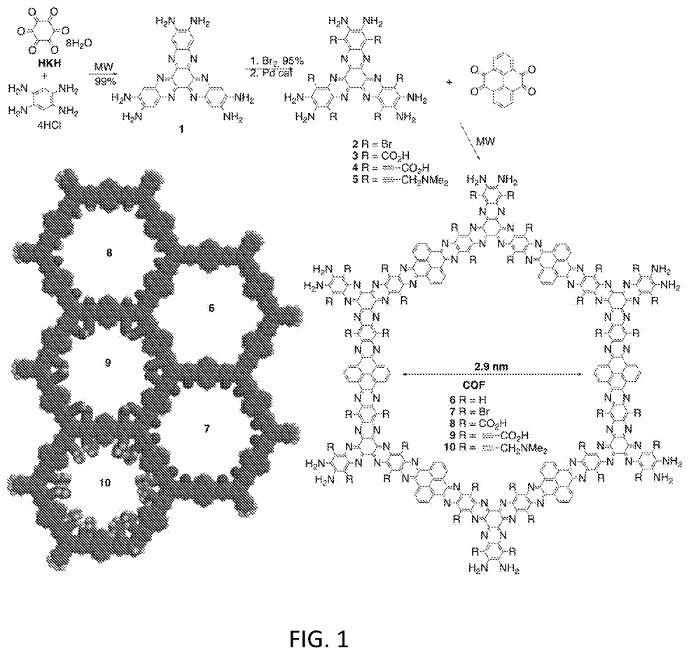

The condensation of amines with ketones in the formation of 2D-COFs is a well-established method for polymer production. (12-19) Of particular importance, was the disclosure by Jiang and co-workers (12) who used a C₃-symmetric hexamine and C₂-symmetric tetraone to produce a highly crystalline, ordered COF in very good yield. This strategy prevents the incorporation of errors in the polymerization step that is inherent in many COF formations and produces highly ordered materials. However, the use of triphenylene hexamine as the C₃-symmetric hexamine is problematic due to cost and the multiple synthetic manipulations that occur in modest overall yield needed to synthesize it. (21) FIG. 1 shows a facile and scalable synthesis to prepare a similar material but one with ready functionalization. Microwave induced condensation of hexaketocyclohexane (22) (HKH) and benzenetetramine produces hexamine 1, (23) that is subsequently brominated to give 2. Formation of 2 allows for the use of metal catalyzed coupling reactions, developed over the past several decades, and provides any number of substituents that can be incorporated into the pores of the 2D-COF. Additionally, the formation of hexaazatrinaphthalene 1 produces an increased pore size vs the use of the triphenylene hexamine used by Jiang. Several palladium catalyzed reactions are performed to produce 3-5, with yields ranging from an unoptimized 55% for the carbonylation to give 3, and 75-80% for 4 and 5, respectively. The R groups illustrate the range of charges that can be put inside the pore from neutral (R═H), positive (R=amine) and negative (R=carboxylate), in addition to varying the size of the pore with the incorporation of the alkyne moiety. Microwave induced condensation of 1-5 with pyrene tetraone resulted in crystalline black powders with yields of 80-95%. Interestingly, under solvothermal conditions in solvents such as N-methylpyrolidinone or acetic acid poor results are obtained in the formation of ordered, crystalline materials. The success observed from the microwave reaction is in part due to an increase in material-wave interactions during the course of the reaction. (24) The overall four-step synthesis provides COFs 6-10 with the overall yields of 50-70%, and to date has produced materials in gram amounts.

### Characterization

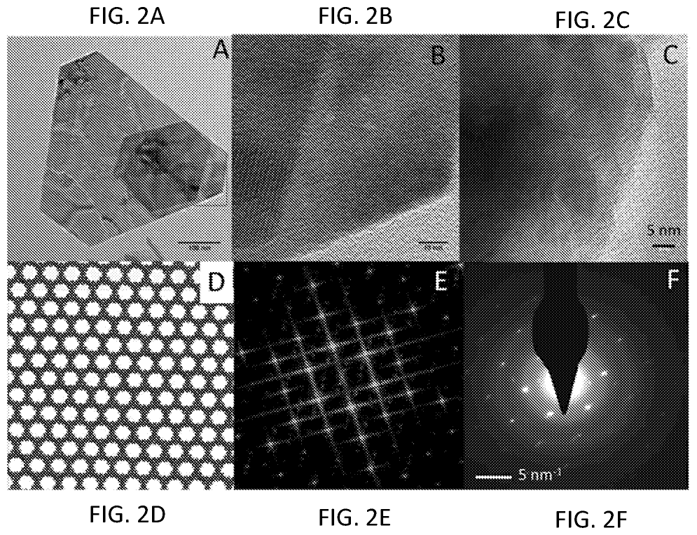

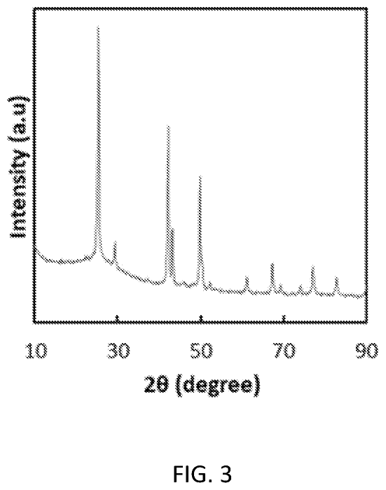

Characterization of the COFs: Transmission electron microscopy (TEM) of the as-synthesized material shows thin crystalline triangular and hexagonal structures that both produce very sharp diffraction spots, as shown in FIGS. 2A-2F. The hexagonal symmetry of the diffraction pattern is consistent with a simulated pattern generated by performing a 2D Fourier transform of a space-filling model. The presence of crystalline structures up to 300 nm on a side in the TEM images is unprecedented for a 2D-COF material. In addition the powder x-ray diffraction pattern COF 9, as shown in FIG. 3, shows a number of sharp peaks that is also unprecedented for a 2D-COF material. A typical example in the literature shows only 3 broad peaks with line widths of ˜x° in comparison with our material multiple peaks with Y° line widths.

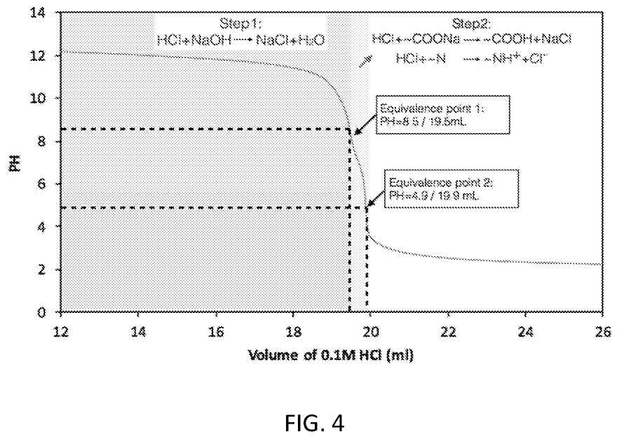

In conjunction with the above characterization, acid-base titration of COF 8 is also performed. A sample of 8 is sonicated with NaOH to produce the sodium carboxylate and to disperse the individual sheets that are then back titrated with HCl. The titration consists of two steps as illustrated in FIG. 4. Specifically, HCl first reacts with the excess NaOH (Step 1, lefthand zone). Second, HCl reacts with 2D-COF-COONa and 2D-COF-N (Step2, righthand zone). The amount of the —COOH in 2D-COF is calculated by the consumption of the standardized HCl in Step 2. From the titration curve, the amount of —COOH groups in the sample are calculated and found to be only 10% lower than the theoretical structure. Since the edge of the 2D-COF sheets can affect the theoretical values, this small discrepancy between titration and theoretical calculation further confirms successful 2D-COF formation with fully functionalized pores. Protonation of the imine moieties in the COF do not occur, which is in agreement with the low pKa's of polyaromatic nitrogen heterocycles such as phenazines. (25)

### Membrane Construction and Testing

Once the structure of the materials is verified, COF 9 is selected for membrane preparation and testing for cation separations. COG 9 is exfoliated in basic water and then poured onto a track-etched polycarbonate membrane support (TEPC) with a pore size of 0.2 μm. Other membrane supports operative herein illustratively include glass, polyethylene (PE), polyvinylidene fluoride (PVDF), alumina, zirconia, mullite, cordierite, silicon carbide, silicon nitride, and stainless steel. Vacuum filtration and curing in a vacuum oven produces a supported membrane (COF/TEPC). According to certain inventive embodiments, an apparatus for ion selectivity measurement includes a U-shaped tube divided by the membrane into two compartments, the feed and permeate sides. The feed compartment is filled with 0.01M of different ammonium and tetra alkyl ammonium salts dissolved in ethanol with the permeate side being filled with just ethanol. Platinum electrodes are placed in both tubes and connected to a potentiostat and then ion transport is measured by recording electrical current voltage curve between 0 V and 2 V. The slope of the linear I-V curves is used to define the resistance of the membrane indicative of the ability to support an ion current across the membrane.

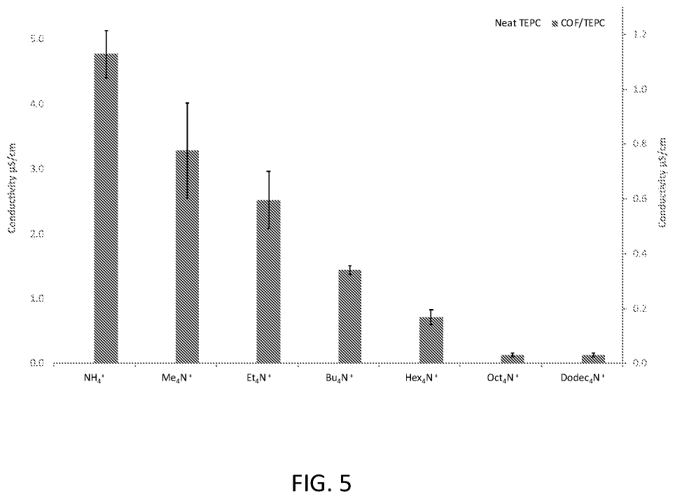

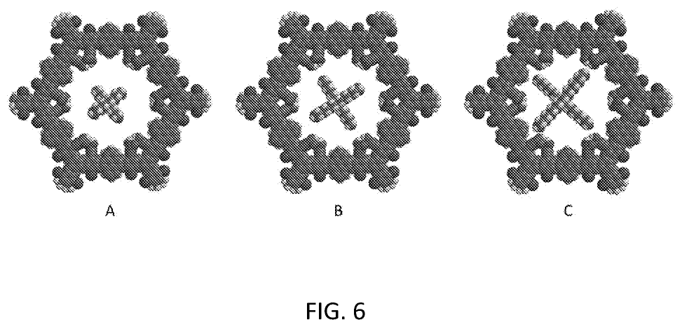

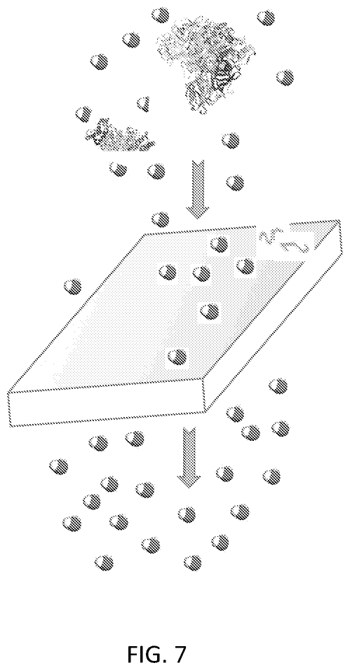

Cation selectivity. Using the cation conductivity of neat TEPC membrane as a control, FIG. 5 reveals that neat TEPC membrane possess higher ion conductivity than all the COF/TEPC membranes, indicating TEPC membranes have large open ion transport pathways for all the cations used in this study. R₄N⁺ cations (R=alkyl) become hydrophobic with a lower ion diffusion coefficient as the chain length of R increases.¹ As a result, these cations went through the same TEPC membrane at different rates, reflected by the different conductivity of the cations of different sizes, with dodecyl₄N⁺ showing the lowest conductivity. Relevant to cation conductivity of neat TEPC membrane, the conductivity of all COF/TEPC membranes is significantly lower, suggesting that the top COF layer greatly increased ion transport resistance. The anions used in the permeate solution are bromide and para-toluenesulfonate and given the large negative charge in the COF pore, are discouraged from traversing the membrane due to the repulsive interactions. Intriguingly, the COF/TEPC membranes demonstrated excellent ion selectivity towards the ammonium cations of various sizes. The higher conductivity of the smaller cations, including NH₄, Me₄N, Et₄N, Bu₄N and Hex₄N, demonstrates that these cations pass through the COF/TEPC membrane, resulting from the fact that the size of these smaller cations (Hex₄N radius=8.2 Å) are smaller than the COF pores (radius=13.5 Å). The decreasing conductivity trend from NH₄⁺ to Hex₄N⁺ for COF/TEPC is similar to that of bare TEPC membrane. Finally, the significantly lower conductivity of COF/TEPC membranes towards larger cations (Oct₄N radius=10.9 Å and dodecyl=15.1 Å) indicates the nearly complete rejection of larger cations by the COF layer, indicating that the top COF layer serves as a size selective cation specific membrane. The small ion current is in part due to the larger cations taking a tortuous path between the 2D COF sheets and in part due to some small anion transport through the membrane. FIG. 6, which depicts a single pore from COF 9 and three different sized cations, illustrates the size selectivity of the membrane. FIG. 7 shows a schematic of an inventive filter membrane selectively filtering particles.

### Experiment 1

A covalent organic framework (COF) containing aromatic backbones and carboxyl functionalized nanopores is synthesized and used as a two dimensional (2D) nanofiller in polyacrylonitrile polymer matrix of ultrafiltration membranes. A series of mixed-matrix ultrafiltration membranes having various concentrations of carboxyl functionalized COF ranging from 0 to 0.8 wt % are investigated. The effect of COF content on the membrane morphology, intrinsic and mechanical properties, separation performance, and fouling propensity are demonstrated. Having 0.8 wt % of COF in the polymer matrix results in a highly permeable mixed-matrix ultrafiltration membrane with enhanced thermal stability, mechanical properties, protein selective, and hydrophilicity

Materials. COF with carboxyl functional groups is synthesized in a laboratory using polyacrylonitrile (PAN), lithium chloride (LiCl), ethanol, dimethylformamide (DMF), poly(ethylene glycol) (PEG, Mw=10,000 g mol-1 and Mw=35,000 g mol-1), poly(ethylene oxide) (PEO, Mw=100,000 g mol-1 and Mw=400,000 g mol-1), bovine serum albumin (BSA), fluorescein isocyanate conjugated bovine serum albumin (FITC-BSA), and polyester non-woven fabric (#3265) having a thickness of ˜53 μm.

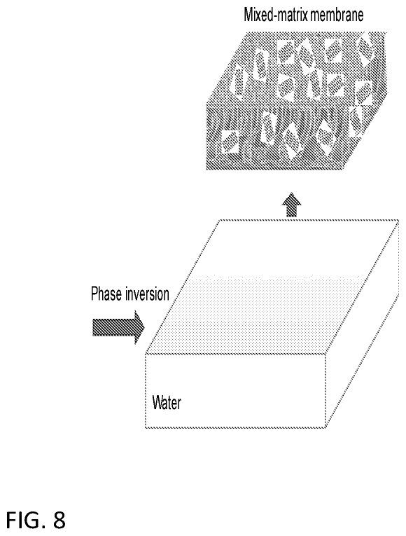

Fabrication of ultrafiltration membrane. Asymmetric ultrafiltration membranes are prepared by phase inversion via immersion precipitation (FIG. 1) using casting solutions containing PAN (7.4 wt %) as the polymer matrix, LiCl (2.5 wt %) and ethanol (3.0 wt %) as additives, COF (0-0.8 wt %) as the nanofiller, and DMF as the solvent. First, the concentrated polymer solution having PAN/LiCl/ethanol/DMF (148/50/60/871, mg) is prepared at 70° C. overnight to obtain a homogeneous solution. Second, COF solutions are prepared by dispersing various amounts of COF ranging from 0 to 16 mg into 871 mg of DMF using bath sonication for 1 h at room temperature. The casting solutions are obtained by mixing the concentrated polymer solution and the COF solution. Then, the casting solution is spread on the surface of non-woven fabric attached on top of a glass plate using a 250 μm gap casting knife, followed by submersing in a water bath at room temperature. The exchange of solvent and non-solvent (water) causes the precipitation of the polymer film resulting the non-woven supported ultrafiltration membrane. The membrane is kept in water for one day to remove the additives and solvent. FIG. 8 is a schematic illustration showing the fabrication of a mixed-matrix ultrafiltration membrane and molecular structures of the polymer matrix (polyacrylonitrile) and the 2D nanofiller (COF) according to embodiments of the present invention.

For some characterizations, membranes without non-woven fabric support are fabricated by spreading polymer solution directly on the glass plate surface using the same method as described for the non-woven supported membrane fabrication.

Characterization of COF. A dispersion of COF in DMF is prepared using the same method as in the membrane fabrication. Immediately after the dispersion, the size of COF sheets is analyzed by dynamic light scattering (DLS) method using a Zetasizer Nano ZS (Malvern Instruments) equipped with a He—Ne laser at room temperature.

The topography and thickness of COF sheets are characterized using a Cypher™ atomic force microscope (AFM) equipped with an Asylum Research ARC2 SPM controller. A drop of COF/DMF dispersion is added on a clean silicon wafer surface and kept in an oven at 80° C. overnight to remove DMF. The sample is operated in tapping mode. A silicon cantilever probe with a resonance frequency of 76-263 kHz and force constant of 1.2-29 Nm-1 is used for the measurement. The acquired imaging data is post-processed using Gwyddion data analysis software.

Powder X-ray diffraction (XRD) pattern of COF is recorded on a Rigaku Smartlab X-ray diffractometer equipped with graphide-monochromatized Cu Kα radiation (λ=1.5406 Å) using Bragg-Brentano focusing.

Phase inversion kinetic study. Phase inversion kinetics of casting solutions are analyzed by light transmittance method. A layer of casting solution with a thickness of approximately 1 mm is cast on a glass slide and then immediately immersed in cuvette containing water as a non-solvent. The change of light transmittance over time is recorded at 600 nm using a SpectraMax Plus 384 UV-Vis (Molecular Devices). The relative light transmittance (Tr, %) was calculated according to Equation 1.

$${T}_{r} = \frac{( T - {T}_{min} )}{( {T}_{max} - {T}_{min} )} \times 100 \% \qquad Equation 1$$

where Tₘᵢₙ, Tₘₐₓ and T are the minimum, maximum, and the transmittance at a time, respectively.

Characterization of membranes. The morphology of membranes is imaged on a scanning electron microscope (SEM), Quanta 450 (FEI). All samples are freeze-dried to completely remove water while maintaining the structure and coated with carbon before imaging. For cross-sectional imaging, the membranes are fractured in liquid nitrogen.

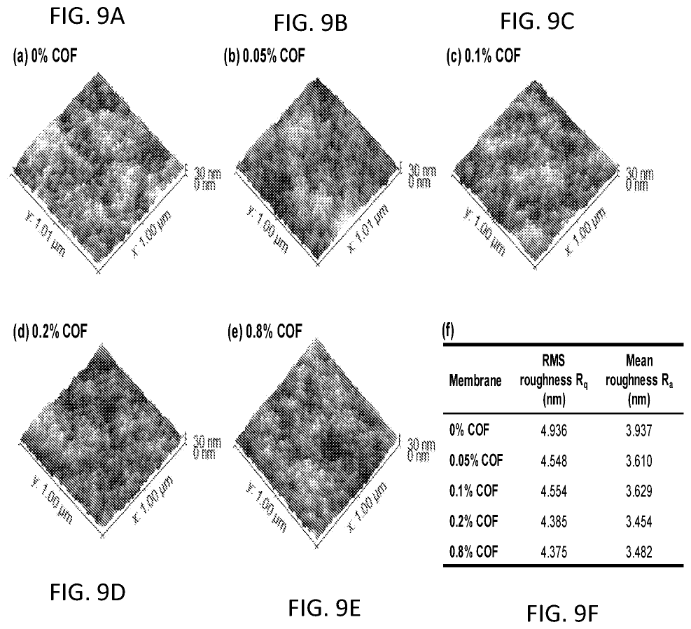

A Cypher™ atomic force microscope (AFM) equipped with an Asylum Research ARC2 SPM controller is used to obtain the topography profiles of the membrane surfaces. The freeze-dried samples are scanned in tapping mode in the air using a silicon cantilever probe with a resonance frequency of 76-263 kHz and force constant of 1.2-29 Nm⁻¹ with a scanning range of 3 μm×3 μm. The acquired imaging data are post-processed using Gwyddion data analysis software, with the results being shown in FIGS. 9A-9E. Root mean squared roughness (R_{q}) and mean roughness (Rₐ) values of membranes are calculated and shown in FIG. 9F.

Static contact angle values of freeze-dried membranes are measured using a Krüss Easydrop (Krüss GmbH, Germany) at room temperature. The measurement is conducted by advancing 1 μL of water on the top surfaces of the membranes.

Membrane chemistry characteristics are determined by a Fourier transform infrared spectroscopy (FTIR) with the attenuated total reflectance (ATR) mode (Nicolet™ iS™ 50 FTIR Spectrometer, Thermo Scientific).

A SDT Q600 thermogravimetric analyzer (TGA) is used to evaluate the thermal stability of membranes under an inner atmosphere. The measurements are conducted from 30 to 700° C. at a heating rate of 10° C./min under argon flow at a rate of 100 mL/min. Freeze-dried membrane samples without non-woven fabric having approximately the same weight of 3 mg are used for each experiment.

The membrane mechanical properties are carried out in air at room temperature using a dynamic mechanical analysis (DMA Q800, TA Instruments). Freeze-dried membranes without non-woven fabric support are used for the mechanical tests. All samples are tested as 5 mm wide strips. The tests are performed under the controlled force mode and the ramp force of 0.4 N/min.

Rigaku Smartlab XRD equipped with graphide-monochromatized Cu Kα radiation (λ=1.5406 Å) is used to obtain XRD patterns of membranes.

The porosity (ε, %) of membranes is determined using gravimetric analysis based on Equation 2.

$$ɛ = \frac{( {m}_{wet} - {m}_{dry} ) / {ρ}_{w}}{( {m}_{wet} - {m}_{dry} ) / {ρ}_{w} + {m}_{dry} / {ρ}_{p}} \times 100 \% \qquad Equation 2$$

where m_{wet} and m_{dry} are the weights of wet membrane without excess water on the surface and the weight of freeze-dried membrane, respectively. And ρ_{w} and ρₚ are the densities of water and polymer, respectively.

Filtration tests. All filtration tests are performed at room temperature under a transmembrane pressure of 1 bar, using a dead-end permeation cell with an effective membrane diameter of 1 cm.

Solvent permeance (Lm⁻²h⁻¹bar⁻¹) and filtered species rejection (%) values are measured to evaluate the membrane separation performance. A solvent operative herein illustratively includes, water, any organic solvents compatible with a given membrane support, gases, and super critical carbon dioxide. It should be appreciated that the COF from which the layer is formed are exceptional stable under a variety of solvents and at elevated temperatures. Filtered species according to the present invention are also a broad class that includes molecules; ions; macromolecules, such as polypeptides, proteins, viruses, bacteria, nanocrystals, colloids, and combinations thereof with the proviso of being sized and/or charged relative to the pores of the two dimensional layer. By way of example, water permeance is calculated by Equation 3.

$$Water premeance = \frac{Δ V}{Δ t {A}_{e f f} Δ P} \qquad Equation 3$$

where ΔV (L) is the volume of deionized water that has permeated through the membrane in a predetermined time Δt (h), A_{eff} is the effective membrane surface area (m²), ΔP is the transmembrane pressure (bar).

Membrane selectivity is illustratively evaluated for a filterable species being the protein separation ability of membranes using 1000 ppm bovine serum albumen (BSA) protein in phosphate-buffered saline (PBS) solution as a feed. The protein rejection (%) is calculated by Equation 4.

$$Rejection = ( 1 - \frac{{C}_{p}}{{C}_{r}} ) \times 100 \% \qquad Equation 4$$

where Cₚ and Cᵣ are the BSA concentration in the permeate and retentate, respectively. BSA concentration is determined by a SpectraMax Plus 384 UV-Vis (Molecular Devices) from the absorption value at 280 nm.

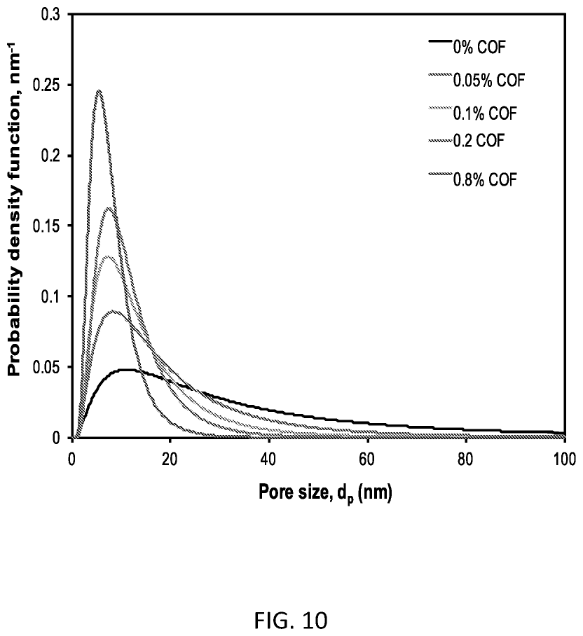

Neutral solute separation is used to determine the pore size distribution, as shown in FIG. 10, mean effective pore size (μₚ), and molecular weight cut-off (MWCO) of membranes. An aqueous solution containing PEG (Mw=10,000 g mol⁻¹ and Mw=35,000 g mol⁻¹) and PEO (Mw=100,000 g mol⁻¹ and Mw=400,000 g mol⁻¹) at a concentration of 50 ppm each solute. The solute rejection is calculated using equation 4. The PEG/PEG concentrations in the permeate and retentate are analyzed by a gel permeation chromatography (GPC) system (Shimadzu) using a RID-20A refractive index detector. Based on the diameter of PEG/PEO and their rejection values, the mean effective pore size (μₚ), pore size distribution and MWCO are determined by ignoring interactions between solutes and membrane pores. The mean effective pore size (μₚ) and MWCO of the membrane is determined at the solute rejection of 50% and 90%, respectively. The pore size distribution of the membrane is conducted using the following probability density function based on Equation 5.

$$\frac{d R ( {d}_{p} )}{d {d}_{p}} = \frac{1}{{d}_{p} ln {σ}_{p} \sqrt{2 π}} exp [ - \frac{{( ln {d}_{p} - ln {μ}_{p} )}^{2}}{2 {( ln {σ}_{p} )}^{2}} ] \qquad Equation 5$$

where σₚ is the geometric standard deviation defined as the ratio of pore diameter at 84.13% rejection over that at 50% rejection.

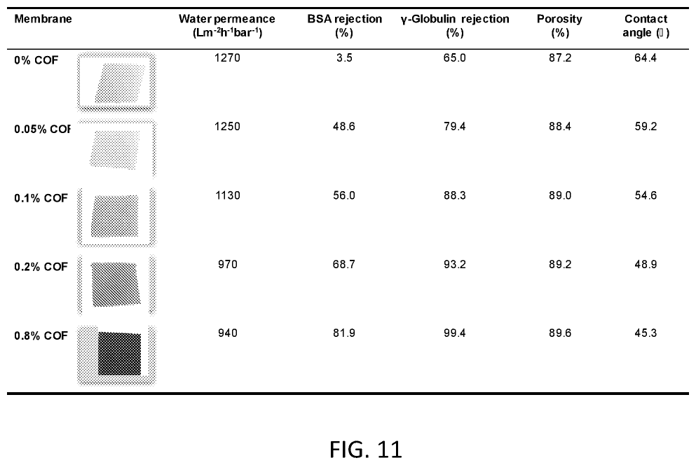

Results of pure water permeance, protein separation, porosity, and water contact angle of membranes are shown in FIG. 11.

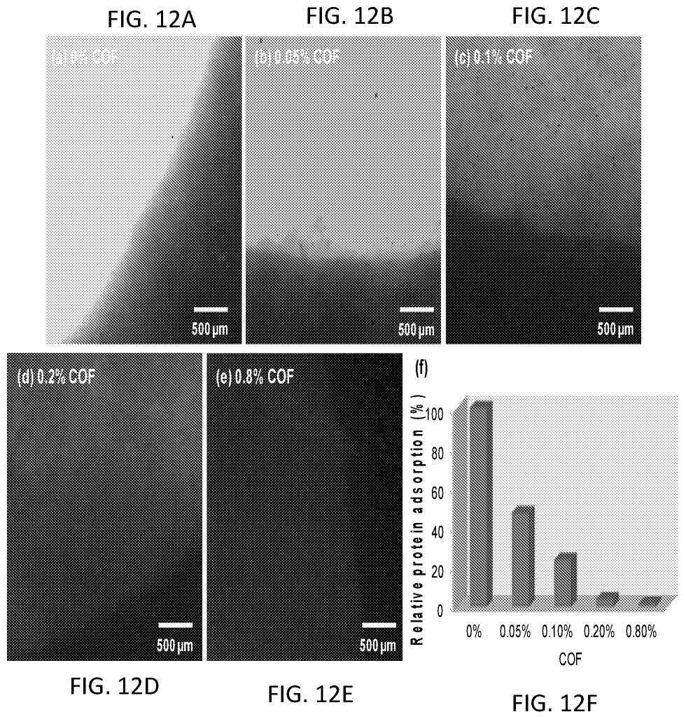

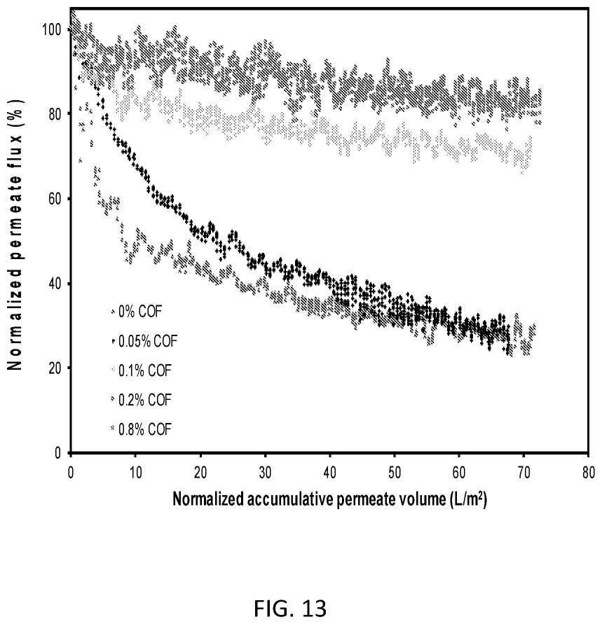

Protein fouling tests. The amount of BSA adsorbed on membrane surfaces are studied to evaluate the fouling resistant ability of membranes under static condition. A solution containing 1000 ppm BSA-FITC in PBS is added on the surface of a pre-wetted membrane for 1 h at room temperature. Subsequently, the membrane is washed to remove un-adsorbed BSA-FITC and dried. The adsorbed BSA-FITC is visualized using an epifluorescence optical microscope (Olympus) with a FITC filter, as shown in FIGS. 12A-12E. The surface density of the adsorbed BSA-FITC is analyzed using ImageJ software. FIG. 13 shows a graph showing flux decline curves using 1000 ppm BSA in PBS solution as the feed.

Protein fouling tests under filtration condition are conducted under transmembrane pressure of 1 bar a using a feed solution having 1000 ppm BSA in PBS. Prior to the fouling experiment, the membrane is stabilized using PBS solution for 30 min.

### Experiment 2

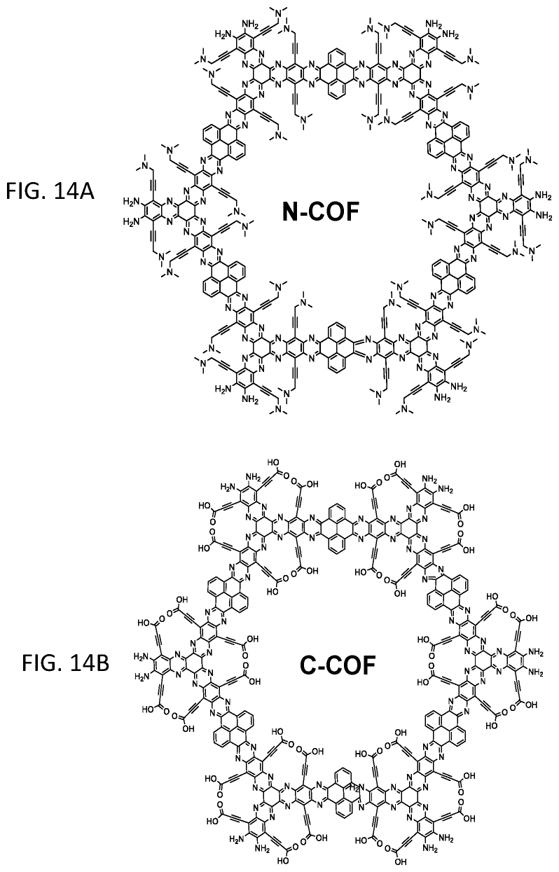

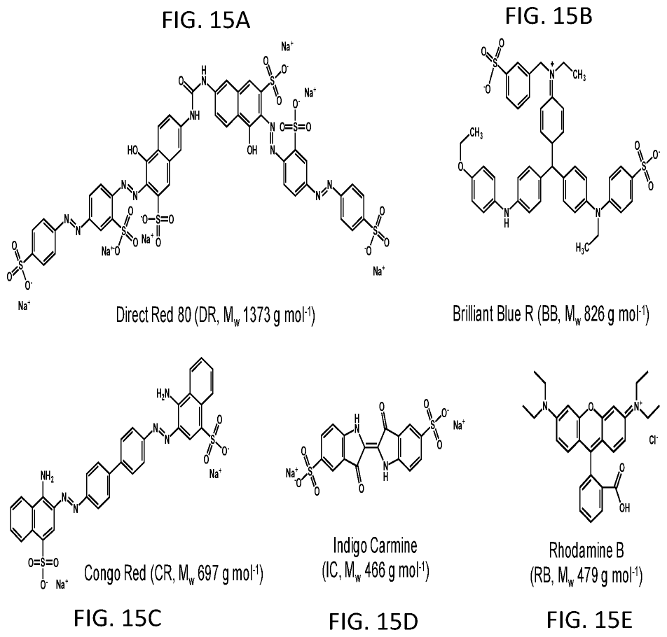

Materials. Two types of COFs, carboxyl functionalized COF (C-COF), FIG. 14B, and tertiary amine functionalized COF (N-COF), FIG. 14A, are synthesized in a laboratory using polyacrylonitrile (PAN), lithium chloride (LiCl), ethanol, dimethylformamide (DMF), trimesoyl chloride (TMC), m-phenylene diamine (MPD), n-hexane, ethyl acetate, methanol, four negatively charged dyes including Direct Red 80 (DR, MW=1373 g mol⁻¹) (FIG. 15A), Brilliant Blue R (BB, MW=826 g mol⁻¹) (FIG. 15B), Congo Red (CR, MW=697 g mol⁻¹) (FIG. 15C), and Indigo Carmine (IC, MW=466 g mol⁻¹) (FIG. 15D), a positively charged dye, Rhodamine B (RB, MW=479 g mol-1) (FIG. 15E), and a polyester non-woven fabric (#3265) having a thickness of ˜53 μm.

Fabrication of PAN support. Asymmetric PAN membranes are prepared by non-solvent induced phase separation process using casting solutions containing PAN (9.6 wt %) as the polymer matrix, LiCl (2.6 wt %) and ethanol (3.2 wt %) as additives, and DMF (84.6 wt %) as the solvent. A thin layer of the casting solution is spread on the surface of non-woven fabric attached on top of a glass plate using a 250 μm gap casting knife, followed by submersing in a water bath at room temperature. The exchange of solvent (DMF) and non-solvent (water) causes the precipitation of the polymer film resulting the non-woven supported PAN membrane. The membrane is kept in water for one day to remove the additives and solvent.

Nanofiltration membrane preparation. Thin-film composite (TFC) nanofiltration membranes are prepared by depositing a thin polyamide layer on top of the PAN support via the conventional interfacial polymerization process. Briefly, the PAN support is immersed in an aqueous solution containing 1 wt % MPD for 5 min, followed by removing the excess MPD solution using a roller. Subsequently, the top surface of the MPD saturated PAN support is exposed to an organic solution having 0.05% (w/v) TMC and 5% (v/v) ethyl acetate in hexane for 1.5 min to form a thin polyamide layer on top of the PAN support. The TFC membrane is dried at room temperature in air for 1.5 min, washed with hexane, and then kept in deionized water.

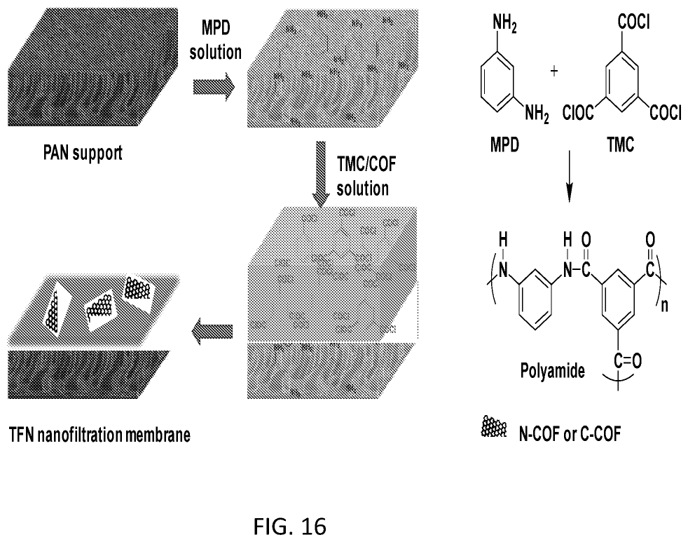

Thin-film nanocomposite (TFN) nanofiltration membranes are fabricated using the same method as described previously for TFC membrane fabrication with a presence of COFs in the organic solutions, as shown in FIG. 16. N-COF and C-COF are dispersed in ethyl acetate at concentrations of 0.5 and 2 mg/mL by sonicating in an Elmasonic for 3 h. The COFs/ethyl acetate dispersions are then added into the TMC/hexane solution resulting homogeneous solutions having 0.05% (w/v) TMC, 0.0025 and 0.01% (w/v) COFs (5 and 20 wt % COFs compared to TMC), and 5% (v/v) ethyl acetate in hexane.

Characterization of COFs. The size of COF sheets in the organic solutions used for TFN membrane fabrication is analyzed by dynamic light scattering (DLS) method using a Zetasizer Nano ZS (Malvern Instruments) equipped with a He—Ne laser at room temperature.

The topography and thickness of COF sheets are characterized using a Cypher™ atomic force microscope (AFM) equipped with an Asylum Research ARC2 SPM controller. A drop of COF dispersions is dropped on a clean silicon wafer surface and left in the fumehood overnight. The sample is operated in tapping mode. A silicon cantilever probe with a resonance frequency of 76-263 kHz and force constant of 1.2-29 Nm⁻¹ is used for the measurement. The acquired imaging data are post-processed using Gwyddion data analysis software.

Powder X-ray diffraction (XRD) pattern of COFs is recorded on a Rigaku Smartlab X-ray diffractometer equipped with graphide-monochromatized Cu Kα radiation (λ=1.5406 Å) using Bragg-Brentano focusing.

Characterization of membranes. The morphology of membranes is imaged on a scanning electron microscope (SEM), Quanta 450 (FEI). All samples are freeze-dried to completely remove water while maintaining the structure and coated with carbon before imaging. For cross-sectional imaging, the membranes are fractured in liquid nitrogen.

A Cypher™ atomic force microscope (AFM) equipped with an Asylum Research ARC2 SPM controller is used to obtain the topography profiles of the membrane surfaces. The freeze-dried samples are scanned in tapping mode in the air using a silicon cantilever probe with a resonance frequency of 76-263 kHz and force constant of 1.2-29 Nm⁻¹ with a scanning range of 3 μm×3 μm. The acquired imaging data is post-processed using Gwyddion data analysis software. Root mean squared roughness (R_{q}) and mean roughness (Rₐ) values of membranes are calculated.

Static contact angle values of freeze-dried membranes are measured using a Krüss Easydrop (Krüss GmbH, Germany) at room temperature. The measurement is conducted by advancing 1 μL of water on the top surfaces of the membranes.

Membrane chemistry characteristics are determined by a Fourier transform infrared spectroscopy (FTIR) with the attenuated total reflectance (ATR) mode (Nicolet™ iS™ 50 FTIR Spectrometer, Thermo Scientific).

Rigaku Smartlab XRD equipped with graphide-monochromatized Cu Kα radiation (λ=1.5406 Å) is used to obtain XRD patterns of membranes.

Filtration tests. All filtration tests are performed at room temperature under a transmembrane pressure of 5 bar using a Sterlitech dead-end permeation cell with an effective membrane area of 14.6 cm².

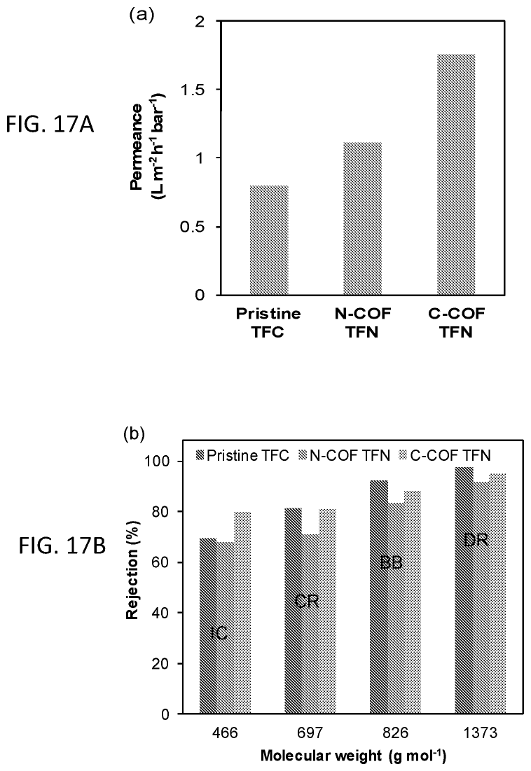

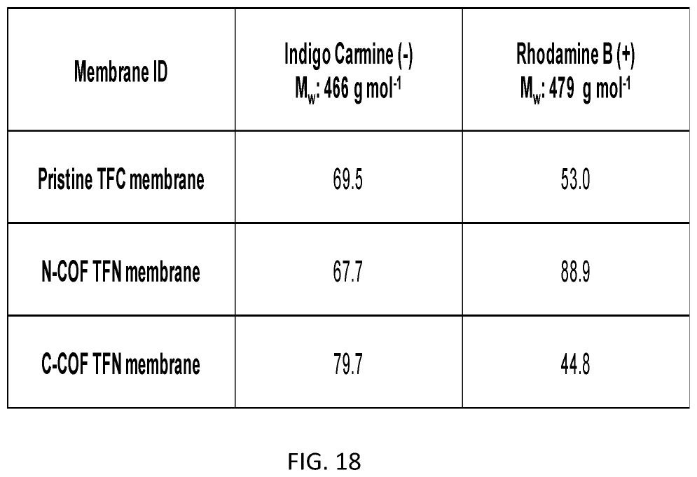

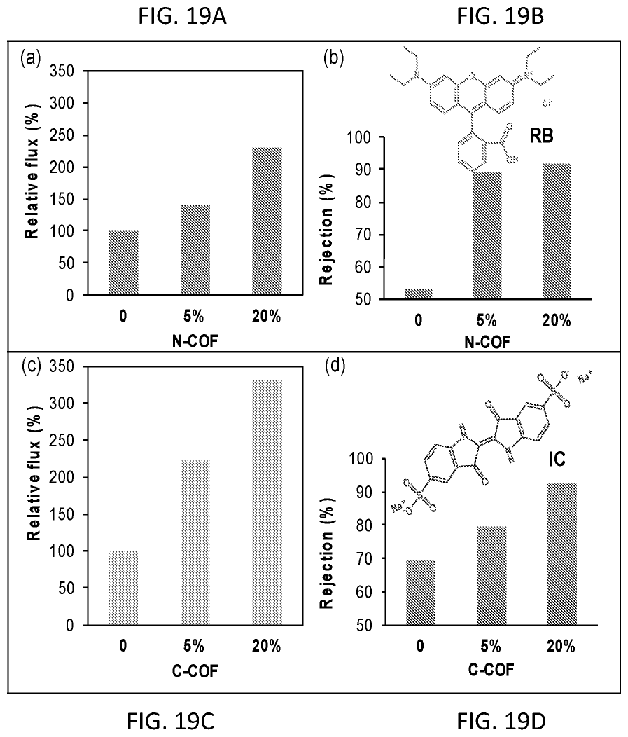

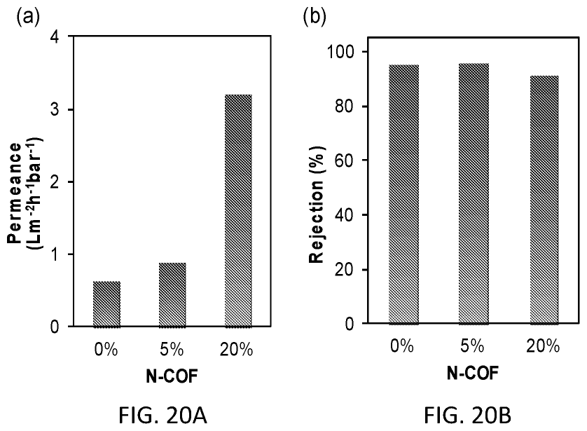

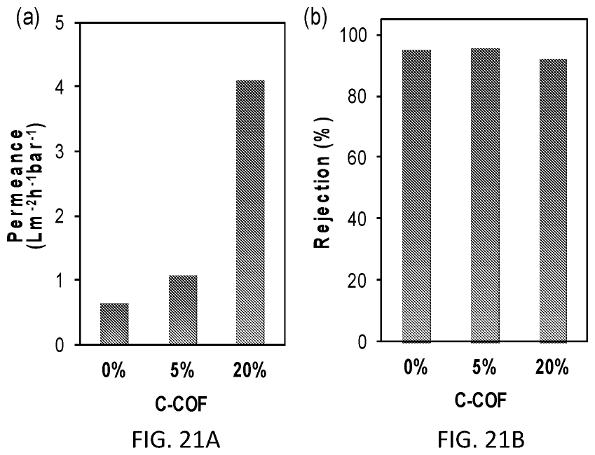

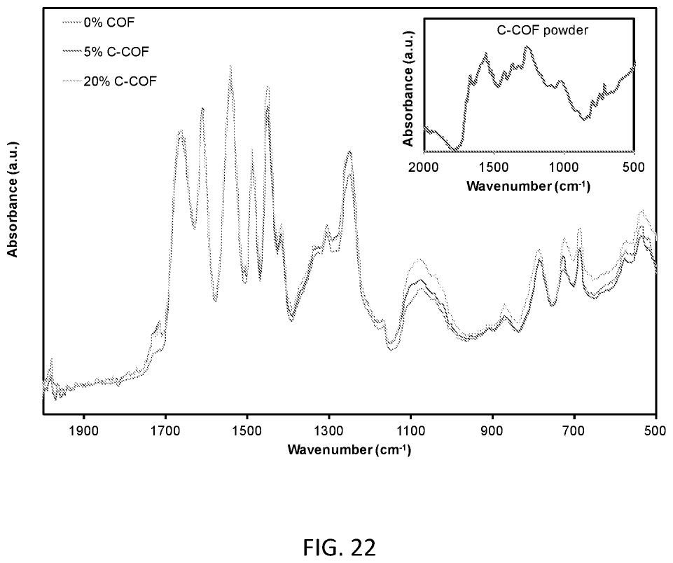

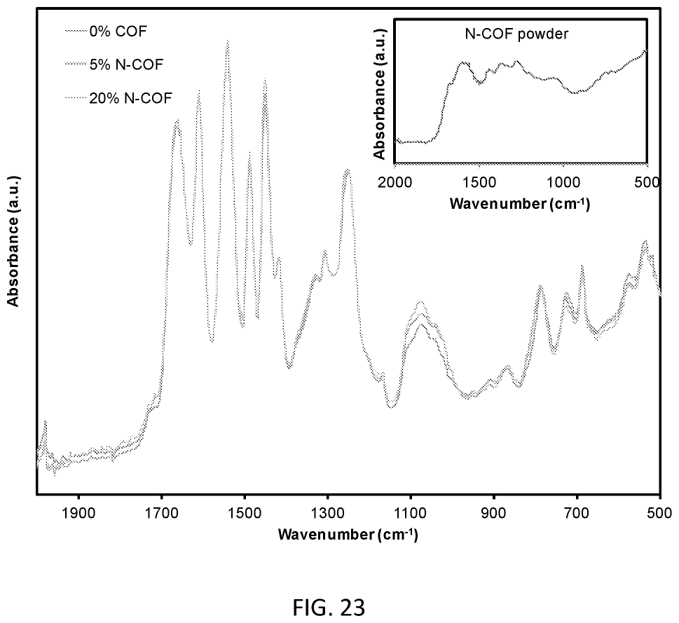

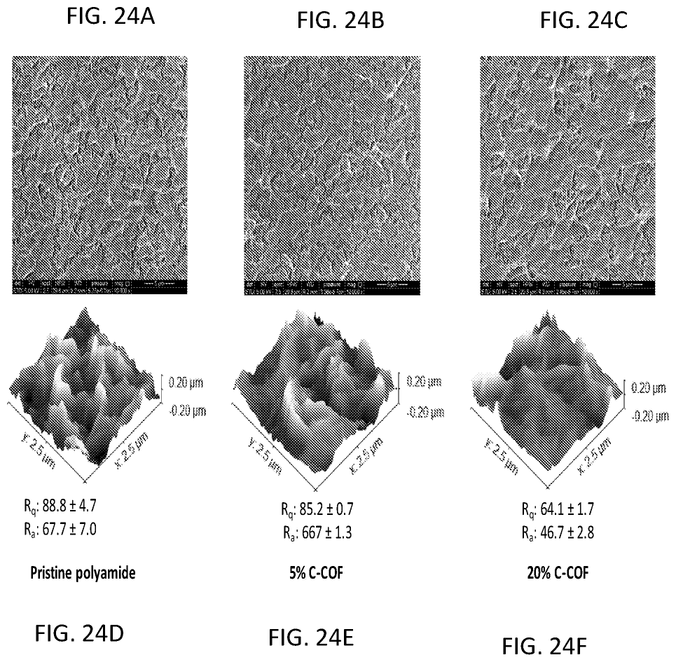

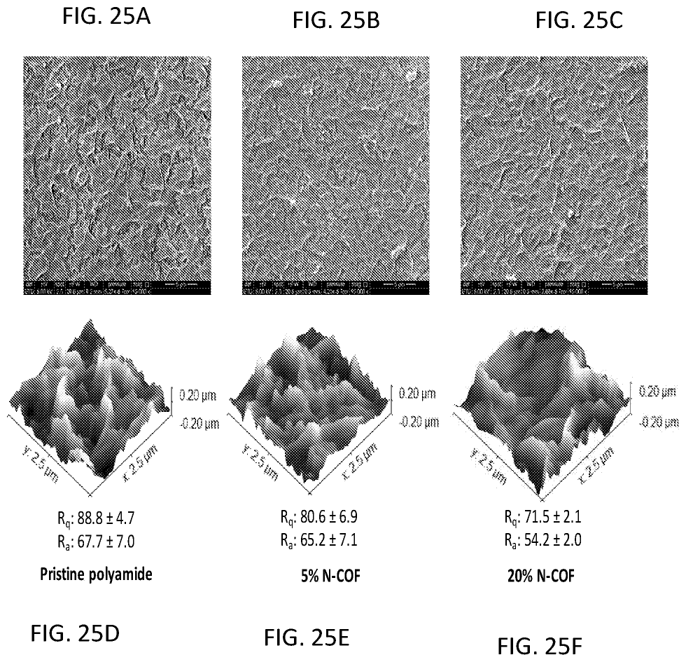

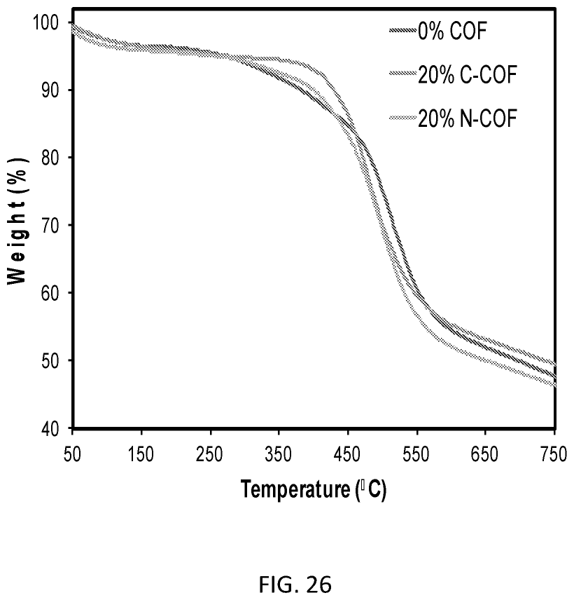

Permeance (Lm⁻²h⁻¹bar⁻¹) and rejection (%) values are measured to evaluate the membrane separation performance. Permeance is calculated using Equation 3 above. The results of the permeance calculations are shown in FIG. 17A. Membrane selectivity is evaluated using organic dyes as model solutes. 20 ppm dye solutions are used as the feeds and the rejection (%) is calculated using Equation 4 above. The results of the rejection calculations are shown in FIG. 17B. FIG. 18 shows a table showing a comparison of separation performance of membranes using two solutes having similar molecular weight, Indigo Carmine (negative charge) and Rhodamine B (positive charge). FIGS. 19A-19D are graphs showing the effect of COF concentration on membrane performance. For membranes having 0-20% N-COF, FIG. 19A shows the relative methanol permeance and FIG. 19B shows the Rhodamine B rejection. For membranes having 0-20% C-COF, FIG. 19C shows relative methanol permeance and FIG. 19D shows Indigo Carmine rejection. FIG. 20A shows water permeance and FIG. 20B shows Orange II (Mw: 350 g mol-1) rejection of nanofiltration membranes having 0-20 wt % N-COF, while FIG. 21A show water permeance and FIG. 21B shows Orange II (Mw: 350 g mol-1) rejection of nanofiltration membranes having 0-20 wt % C-COF. FIG. 22 is a graph showing the ATR-FTIR spectra of polyamide membranes having 0-20 wt % C-COF and FTIR spectrum of C-COF powder. FIG. 23 is a graph showing the ATR-FTIR spectra of polyamide membranes having 0-20 wt % N-COF and FTIR spectrum of N-COF powder. FIGS. 24A-24C show SEM morphology of membrane surfaces of pristine polyamide, 5% C-COF, and 20% C-COF, respectively, while FIGS. 24D-24F show AFM topography of membrane surfaces of pristine polyamide, 5% C-COF, and 20% C-COF, respectively. Similarly, FIGS. 25A-25C show SEM morphology of membrane surfaces of pristine polyamide, 5% N-COF, and 20% N-COF, respectively, while FIGS. 25D-25F show AFM topography of membrane surfaces of pristine polyamide, 5% N-COF, and 20% N-COF, respectively. Finally, FIG. 26 is a graph showing TGA curves of the pristine (0% COF), 20% C-COF, and 20% N-COF incorporated polyamide films.

### Experiment 3

Next various applications for the COF composite membranes are explored.

1. COF Composite Membranes for Textile Wastewater Treatment

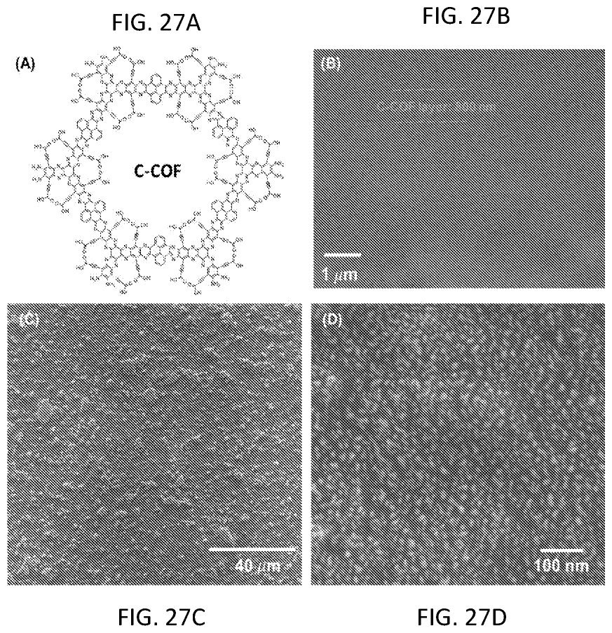

Carboxyl-functionalized COF (C-COF), which is shown in FIG. 27A, is dispersed in dimethylformamide (DMF) at concentrations of 0.1 mg/mL by sonicating in an Elmasonic at ice-cold temperature for 3 h. The dispersion is kept at room temperature overnight before transferring 20 mL of the supernatant onto AAO membrane (20 nm pore size, Whatman) for vacuum filtration to form C-COF/AAO membrane. The as-prepared C-COF/AAO membrane is dried at 80° C. for 5 min before the measurements. FIG. 27B is a cross-sectional SEM image of a C-COF/AAO membrane, FIG. 27C is a surface SEM micrograph of C-COF/AAO membrane, and FIG. 27D is a zoomed in surface SEM image of a smooth region of the C-COF/AAO membrane. C-COF/AAO membranes constructed with C-COF on a porous anodic aluminum oxide (AAO) filter contain a C-COF layer with a thickness of approximately 800 nm as shown in FIG. 27B. As shown in FIGS. 27C and 27D, the membrane surface is not as smooth as reported graphene oxide (GO) membranes.

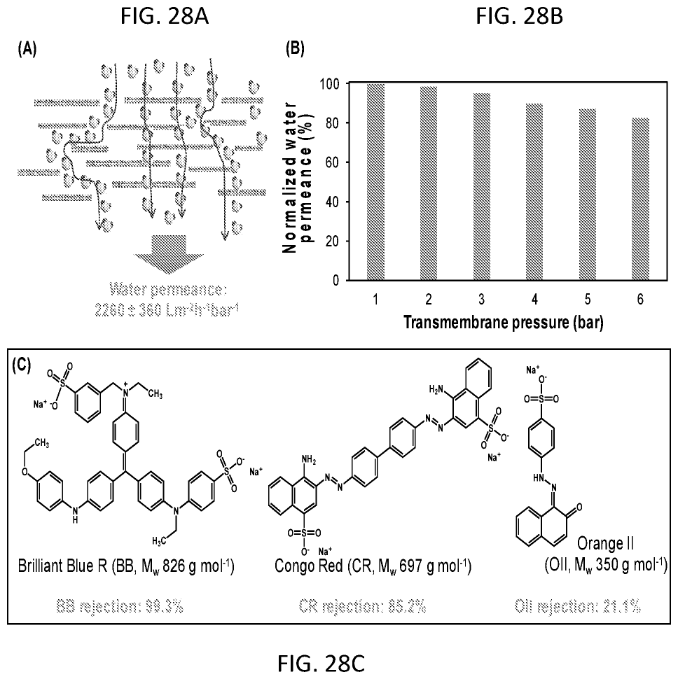

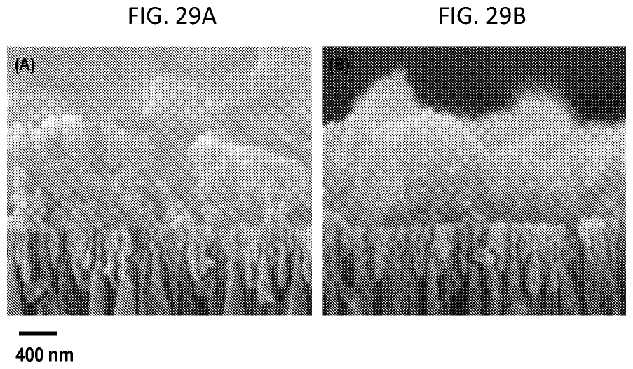

The water permeance of the membranes is measured under a transmembrane pressure of 1 bar. It is well established that water transports predominantly through GO membranes via an interlayer flow between the nano-sheets. Although interlayer flow is also feasible for C-COF/AAO membranes, the high density of hydrophilic nanopores allows for facile water transport through the pores, as shown in FIG. 28A, resulting in a far superior water permeance of ˜2260 Lm-2h-1bar-1. Membrane compaction, under pressure-driven membrane separation processes, is a well-known issue that reduces membrane performance. Therefore, the performance of C-COF/AAO membranes are carried out under various applied transmembrane pressures from 1 to 6 bar using DI water as a feed. Given that the AAO support membrane has a high rigidity with negligible compaction under high pressure, and no membrane fouling or concentration polarization occurs with DI water, the reduction of water permeance is due to the compaction of C-COF layers. C-COF/AAO membranes retain a high water flux under high transmembrane pressure (˜82% at 6 bar), further indicating that the nanopores of C-COF are the main water transport pathway versus tortuous path of flow through interlayer spacing. In fact, the small loss of water flux of the COF 9 membrane could be inhibition of the interlayer flow pathway. FIG. 28B is a graph showing the effect of the transmembrane pressure on water permeance through C-COF/AAO membranes. FIG. 28C shows the rejection values of C-COF/AAO membranes using various feed solutions containing 20 ppm dyes in DI water. The membranes exhibit excellent rejection towards Brilliant Blue R with a rejection rate of 99.3%. Lower rejection rates of 85.2% and 21.1% can be obtained for Congo Red and Orange II, respectively. Furthermore, cross-sectional SEM images of C-COF/AAO membranes before and after filtration, as shown in FIGS. 29A and 29B, indicate that the C-COF layer structure remains unchanged during the filtration process.

2. COF Composite Membrane for Produced Water Treatment

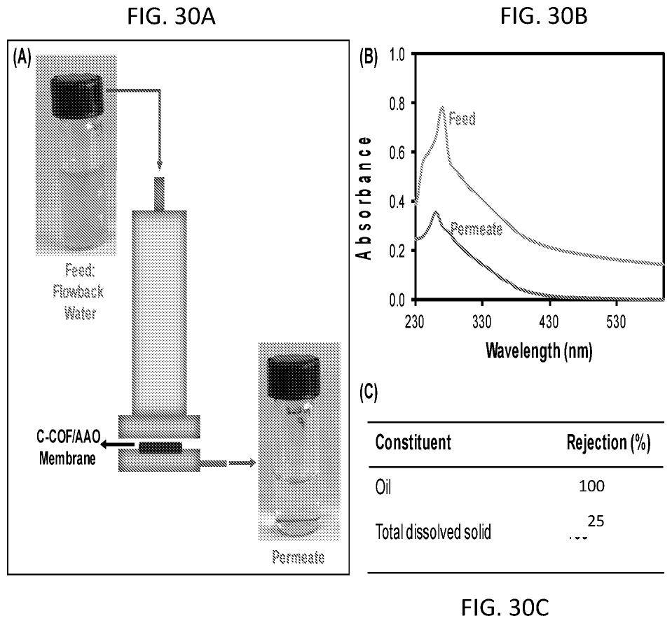

C-COF/AAO membranes with pure water permeance of ˜2260 Lm⁻²h⁻¹bar⁻¹ are used to treat flowback water from shale gas production using a filtration set-up as shown in FIG. 30A. The results in the graph of FIG. 30B and in the table of FIG. 30C show that the membrane removes suspended and emulsified oil completely from the flowback water with a rejection rate of 100%. The total dissolved solid rejection is 25%.

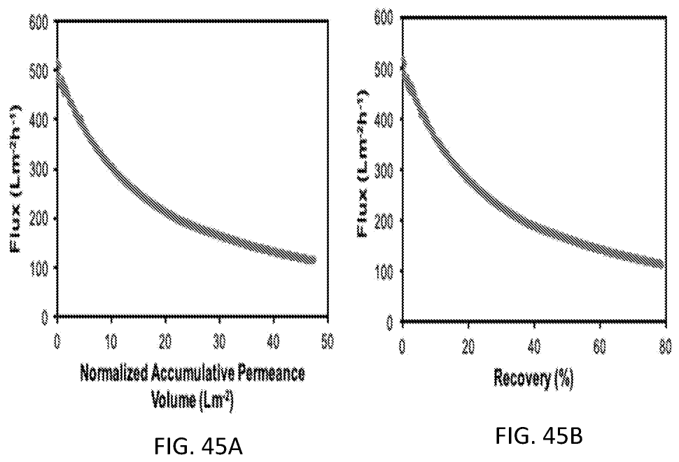

Fouling propensity of C-COF/AAO membranes is analyzed by monitoring the permeance of the membrane over the filtration period, as shown in FIGS. 45A and 45B. Raw flowback water (FBW) from shale gas production was used as a feed and a transmembrane pressure of 1 bar is applied. Two types of FBW are used: one is untreated and the other was treated by acid at the wellhead.

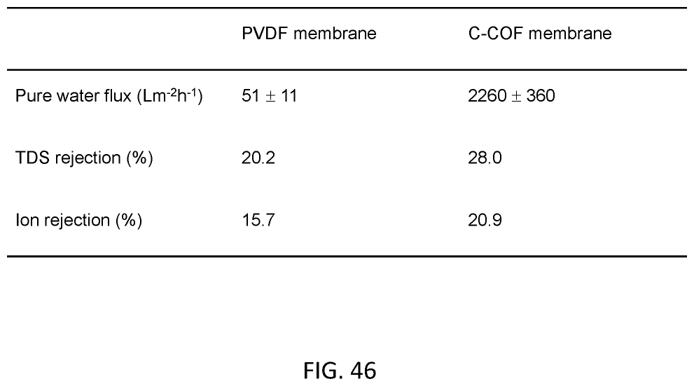

Separation performance of C-COF/AAO membranes is compared with a commercial PVDF UF membrane (Sterlitech, 50 kDa). The separation process is performed under a transmembrane pressure of 1 bar using raw flowback water as a feed. As shown in FIG. 46, the C-COF membrane exhibits superior separation performance than the PVDF membrane.

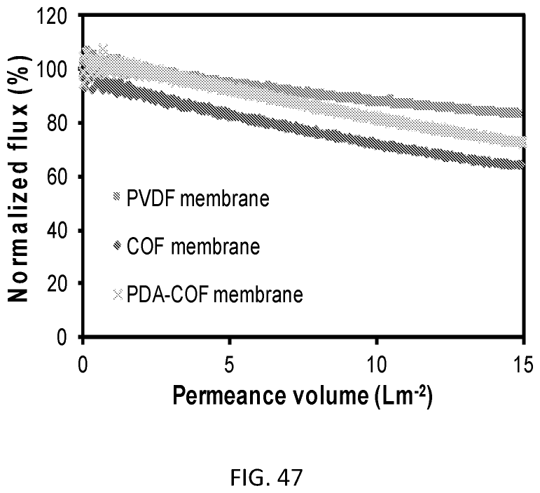

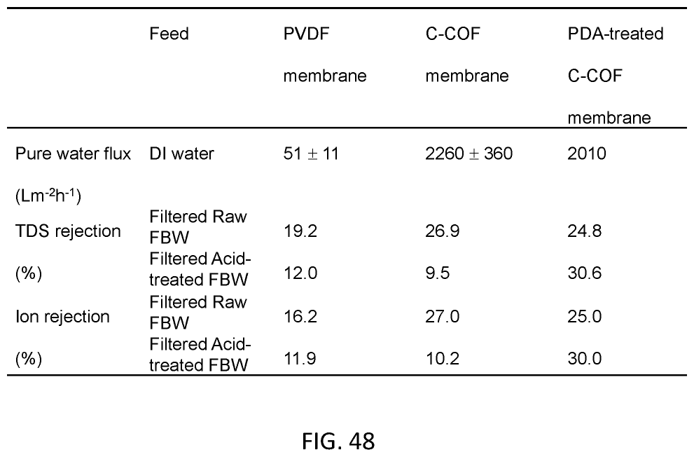

Raw flowback water is filtered using a commercial PES microfiltration membrane filter (median pore size: 0.45 mm) in order to evaluate fouling resistance of COF membranes. For simplicity, the filtered FBW is referred to as ‘filtered raw FBW’ when it was not pretreated with acid, while the acid-treated water as ‘filtered acid treated FBW’. All the membranes are operated at the same initial pure water flux of ˜250 Lm-2h⁻¹ by adjusting operating pressure. As a result, neat commercial PVDF, COF and polydopamine modified COF membranes (PDA-COF) require 3.5, 0.10 and 0.11 bar, respectively. PDA-COF membranes are fabricated by exposing the top surface of the C-COF membranes to 0.2 mg/mL of dopamine solution (pH 8.5) for 15 min. FIG. 47 is a graph showing flux decline curves of PVDF (Sterlitech, 50 kDa), COF, and PDA-COF membranes. The table of FIG. 48 shows comparisons of a commercial PVDF, COF, and PDA-treated-COF membranes for neat (pH 6) and acid (pH 1.8) flowback water (FBW) treatment. The flowback water feeds are pre-treated using a 0.45 μm PES membrane.

3. COF Composite Membranes for Protein Separation

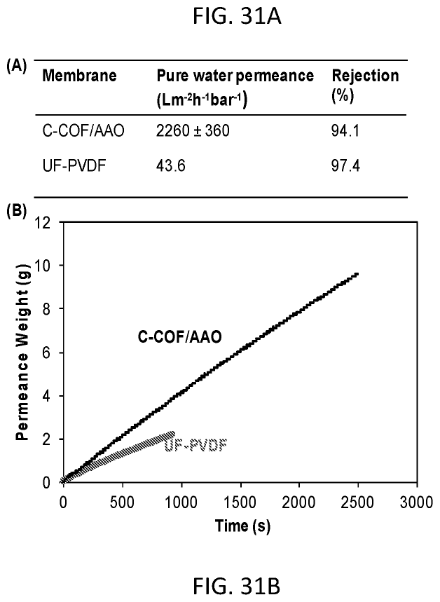

C-COF/AAO membranes with pure water permeance of ˜2260 Lm⁻²h⁻¹bar⁻¹ are used for protein separation applications using 500 ppm γ-globulin as a feed. Compared to a commercially available ultrafiltration (UF) polyvinylidene difluoride (PVDF) membrane (YMBN3001, Sterlitech Corporation) with water permeance of ˜43 Lm⁻²h⁻¹bar⁻¹, the C-COF/AAO membrane exhibits ultra-fast water permeance of ˜2260 Lm⁻²h⁻¹bar⁻¹ while having comparable protein rejection, as shown in the table of FIG. 31A. In addition, the C-COF/AAO membrane has lower protein fouling propensity than the UF-PVDF membrane as shown in FIG. 31B.

4. COF Composite Membranes for Organic Solvent Resistant Nanofiltration

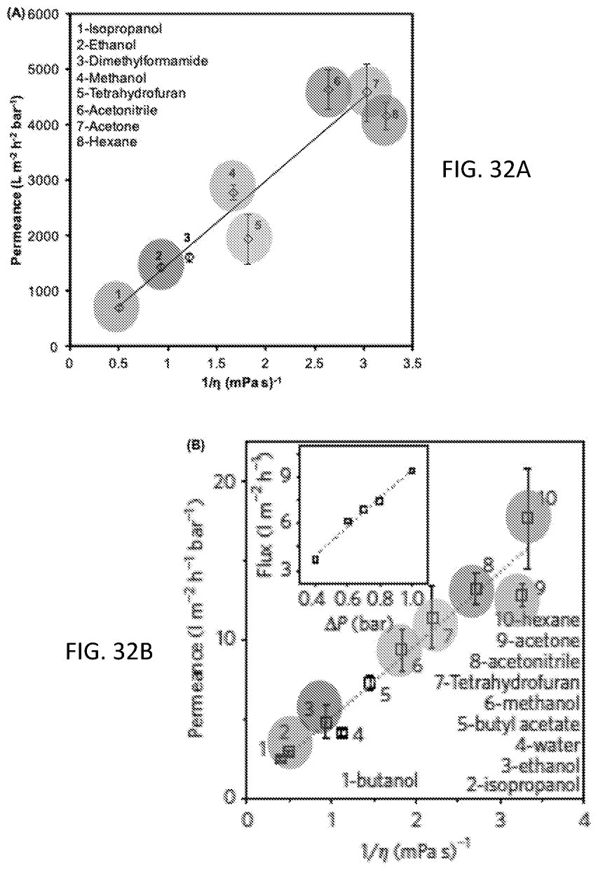

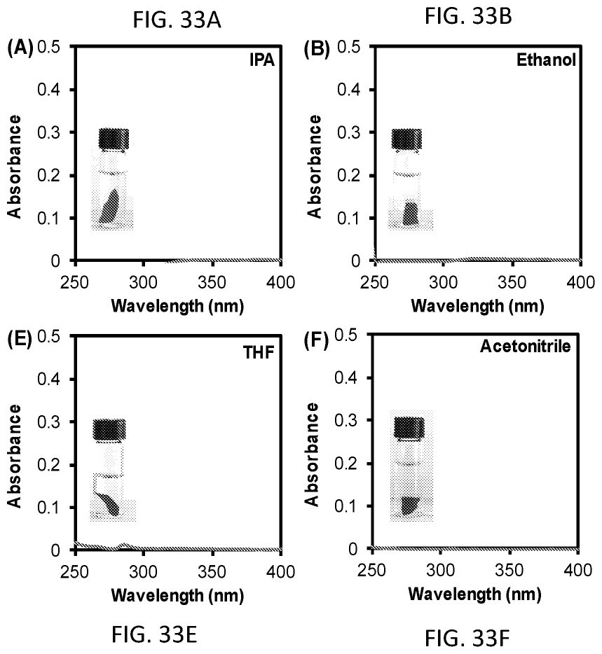

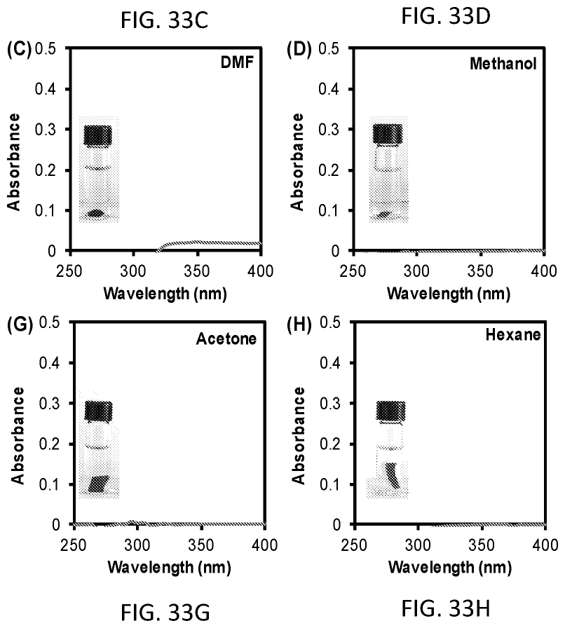

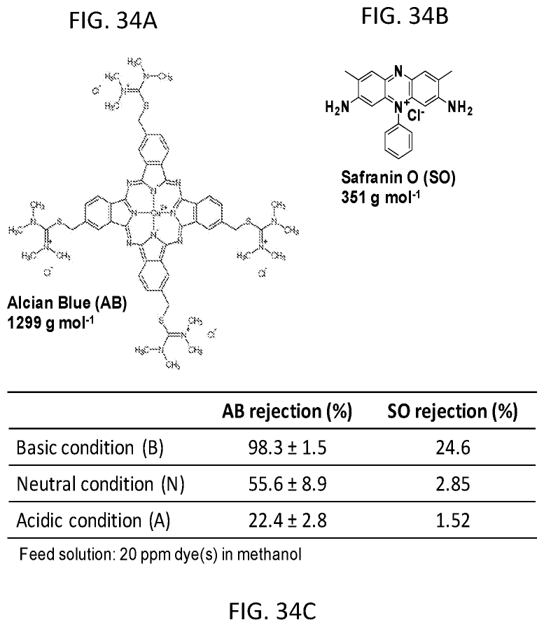

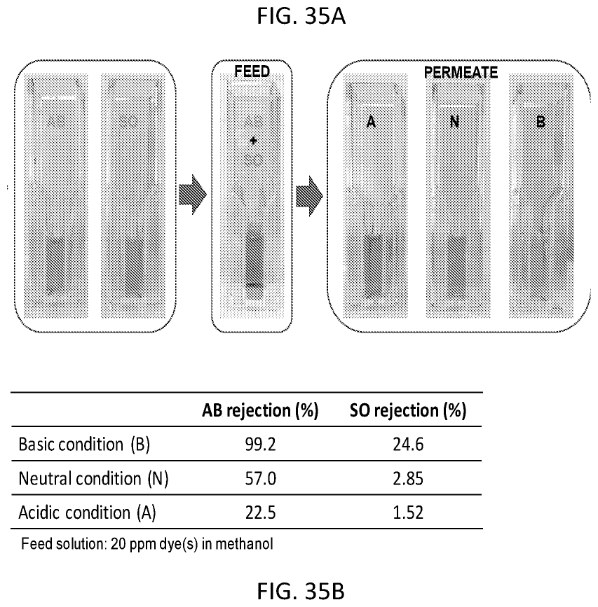

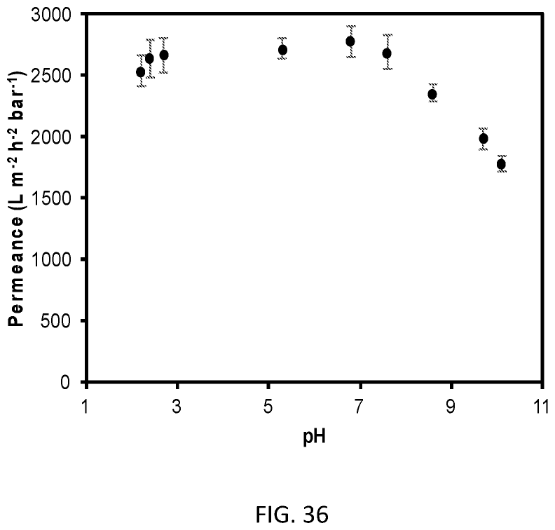

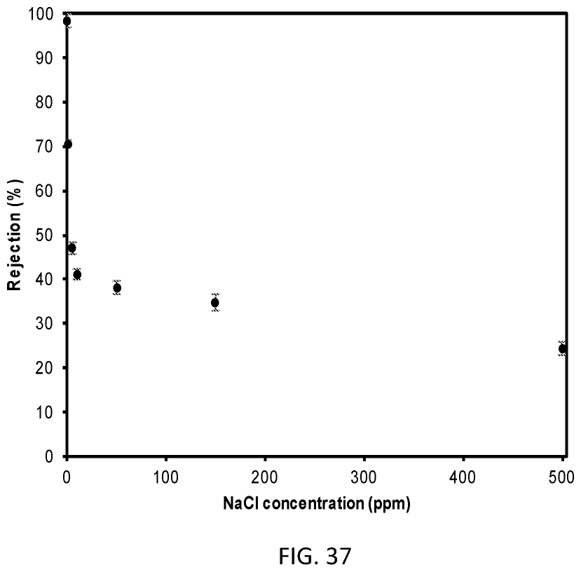

C-COF/AAO membranes containing a layer of carboxyl-functionalized COF as a selective skin and a AAO membrane (20 nm pore size, Whatman) as a support are used. Permeance of various pure organic solvents (isopropanol, ethanol, dimethylforamide (DMF), methanol, tetrahydrofuran (THF), acetonitrile, acetone, and hexane) through C-COF/AAO membranes are measured under a transmembrane pressure of 1 bar. Rejection of several dyes are evaluated using feed solutions containing 20 ppm dyes. FIG. 32A shows the permeance of pure organic solvents of C-COF/AAO membranes as a function of the solvent inverse viscosity. Compared to the reported GO/AAO membranes, the solvents transport through C-COF/AAO membranes with permeance rates of approximately 200 times faster. C-COF/AAO membranes remained intact after immersing in various organic solvents for 7 days, as shown in FIG. 33A-33H. FIG. 34C is a table showing the rejection of Alcian Blue, shown in FIG. 34A, and Safranin O, shown in FIG. 34B in basic, neutral, and acidic methanol feed solutions containing a single dye. FIGS. 35A and 35B show rejection of Alcian Blue and Safranin O in basic, neutral, and acidic methanol feed solutions containing both dyes. FIG. 36 is a graph showing methanol permeance of C-COF/AAO membranes using feeds at different pH, while FIG. 37. Is a graph showing rejection of Alcian Blue using basic methanol feeds containing 0-500 ppm NaCl.

5. 5. Layer-by-Layer COF Composite Membranes for Organic Solvent Resistant Nanofiltration.

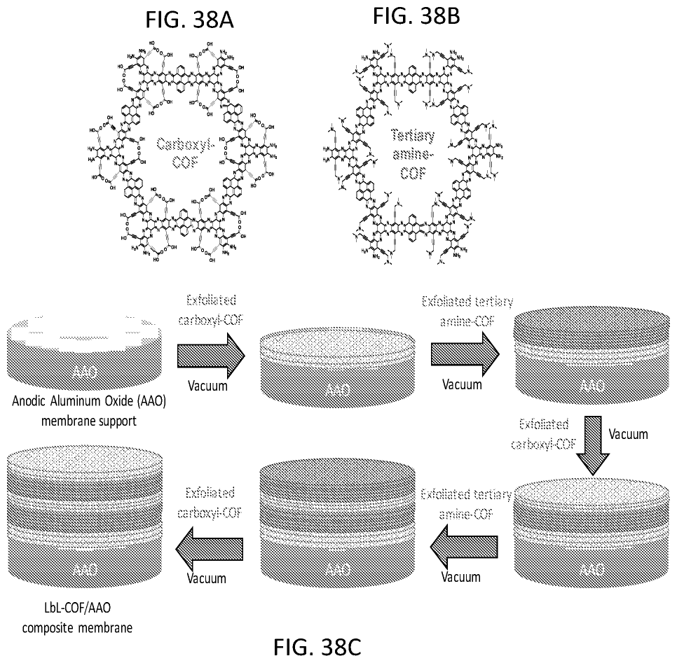

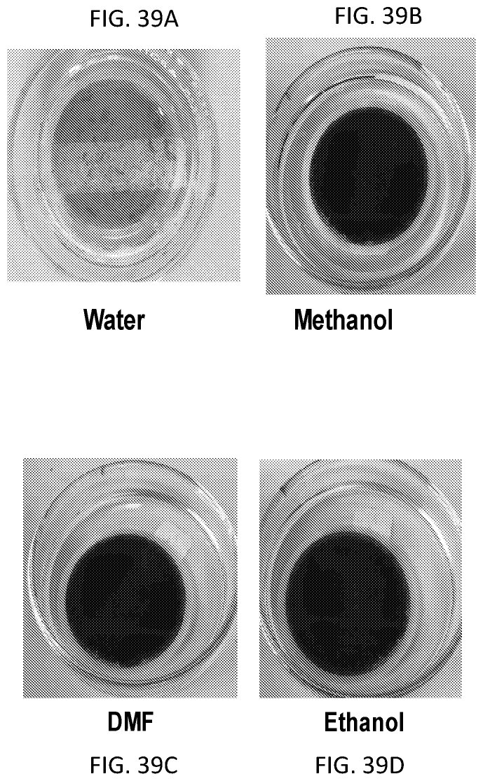

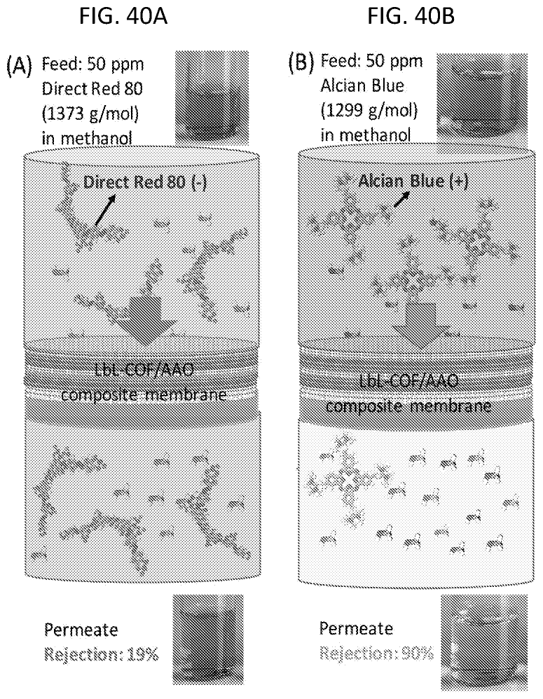

The layer-by-layer (LBL) COF/AAO membranes were fabricated using C-COF and tertiary amine-COF (N-COF) as shown in FIGS. 38A and 38B. FIGS. 39A-39D are Photographs showing the stability of LbL-COF/AAO composite membrane. The membrane readily disintegrates in water after immersing while remained intact in methanol, DMF, ethanol after 30 min. The layer by layer make up of such membranes is shown in FIG. 38C. The LbL-COF/AAO membranes exhibits ultra-fast methanol permeance of 3200 Lm⁻²h⁻¹bar⁻¹. The membrane-solvent-solute interactions determine solvent flux and solute rejection. A system with a stronger affinity between solute and membrane than between solute and solvent, a lower retention would be expected. FIGS. 40A and 40B show the retention ability of the LbL-COF/AAO composite membrane towards two dyes having similar molecular weight (approximately 1300 gmol⁻¹) but opposite charges in methanol. The top layer of the LbL-COF/AAO composite membrane is carboxyl-COF which has a stronger affinity to the positively charged dye (Alcian Blue) than the negatively charged dye (Direct Red 80). However, the membrane shows higher rejection of Alcian Blue (90%) than that of Direct Red 80 (19%)

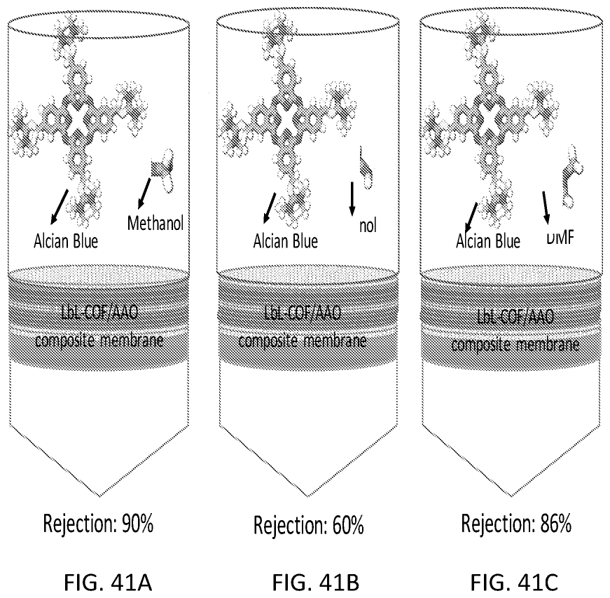

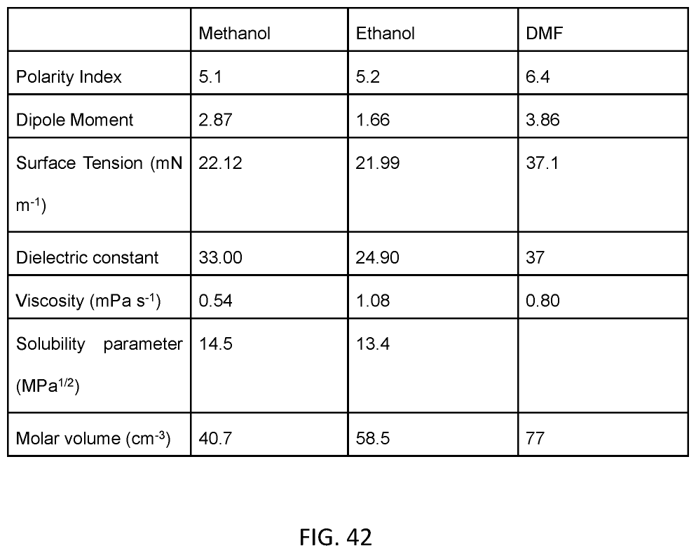

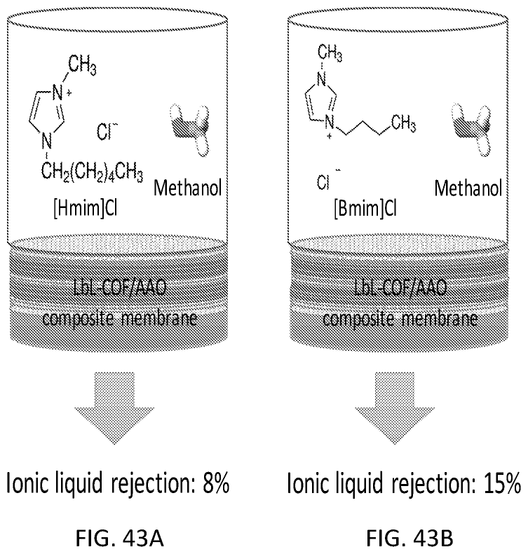

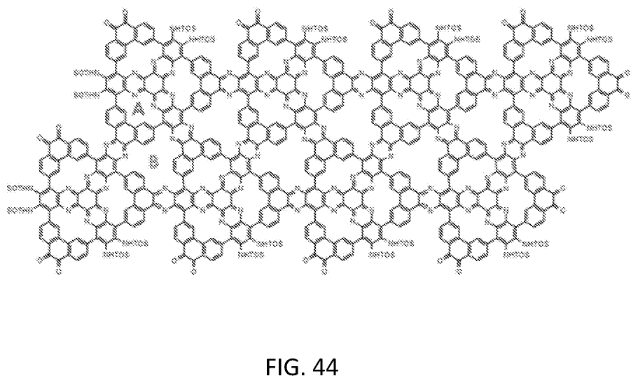

FIGS. 41A-41C show the separation performance of the LbL-COF/AAO membrane towards Alcian Blue in different solvents including methanol (FIG. 41A), ethanol (FIG. 41B), and DMF (FIG. 41C). The Alcian Blue rejection values through the membrane are 90%, 60%, and 86% for methanol, ethanol, and DMF as solvents, respectively. The different physical properties of solvents, shown in the table of FIG. 42, lead to different COF-solvent and solute-solvent interactions, resulting different dye retention effects. FIGS. 43A and 43B show the selectivity of LbL-COF/AAO composite membrane towards [Hmim]Cl (Mw: 203 g/mol) and [Bmim]Cl (Mw: 175 g/mol) ionic liquids. In this particular example, the feed solutions contain 5 wt % of ionic liquid in methanol.

6. COF Membranes for Gas Separation.

COF/AAO composite and COF/polyetherimide (PEI) mixed-matrix membranes are fabricated using COFs with molecular structure as shown in FIG. 44. Compared to the pristine PEI membrane (no COF), the COF/PEI mixed-matrix membrane increases the selectivity of CO2/O2 and CO2/N2 1.04 and 0.9 to 1.43 and 1.11, respectively. No significant selectivity is observed for COF/AAO membranes due to the defects of COF flakes.

Accordingly, the present disclosure provides highly ordered 2D COF materials with tunable pores and demonstrated the synthesis of multiple pore functionalities. According to embodiments, a cation selective membrane with precise size-selectivity is provided. The synthetic flexibility of this system allows for rational design and synthesis of membrane materials for many different types of separations based on size, charge, hydrophobicity and hydrophilicity among others with potential applications in desalinization, non-protein fouling membranes, fuel cell membranes, redox flow battery membranes, dialysis membranes, gas separation membranes and other technologies requiring membrane separations, with some of them already being pursued in our laboratories.

The above experiments show similar permeance and selectivity for dye molecules of a variety of sizes and charges from aqueous solutions, as well as dyes from organic solutions such as tetrahydrofuran and toluene as a function of size or shape.

The present invention is further detailed with respect to the following drawings. These figures are not intended to limit the scope of the present invention but rather illustrate certain attributes thereof.

1. A membrane filter comprising:
an ordered functional nanoporous material (OFNM) defining a layer, said layer having a two-dimensional structure and defining a plurality of pores; and
a membrane support, said layer imparting to the membrane filter a permeance of at least 900 Lm⁻²h⁻¹bar⁻¹ and a rejection of at least 60% as to a solvent containing a filterable species.

2. The membrane filter of claim 1 wherein said layer is configured to allow the solvent to pass through the plurality of pores and to prevent filterable species in the solvent from passing through the plurality of pores based on a size or charge of the filterable species.

3. The membrane filter of claim 1 wherein said layer has an ion conductivity configured to support an ion current.

4. The membrane filter of claim 3 wherein said layer repels negatively charged ions from crossing therethrough.

5. The membrane filter of claim 1 wherein the two-dimensional structure includes a plurality of interlined hexagonal structures.

6. The membrane filter of claim 5 wherein the hexagonal structures are symmetric.

7. The membrane filter of claim 1 wherein the two-dimensional structure is a crystalline structure.

8. The membrane filter of claim 7 wherein the crystalline structure is up to 300 nm.

9. The membrane filter of claim 1 wherein the filter is gravity fed.

10. The membrane filter of claim 1 wherein the membrane filter is formed of a two-dimensional covalent organic framework (COF) polymer.

11. The membrane filter of claim 10 wherein the COF is a carboxyl functionalized COF.

12. The membrane filter of claim 10 wherein the COF is tertiary amine functionalized COF.

13. The membrane filter of claim 12 configured for use with produced water treatment.

14. The membrane filter of claim 12 configured for use with wastewater treatment.

15. The membrane filter of claim 12 configured for use with protein separation.

16. The membrane filter of claim 12 configured for use with solvent resistant nanofiltration.

17. The membrane filter of claim 12 configured for use with organic solvent resistant nanofiltration.

18. The membrane filter of claim 12 configured for use with gas separation.

19. The membrane filter of claim 12 wherein the membrane filter has a water permeance of at least 2000 Lm⁻²h⁻¹bar⁻¹.
